(19) United States
(12) Patent Application Publication
(10) Pub. No.: US 2026/0113701 A1
(43) Pub. Date: Apr. 23, 2026

(54) METHODS AND SYSTEMS FOR MANAGEMENT FUNCTION SELECTION

(71) Applicant: Huawei Technologies Co., Ltd., Shenzhen (CN)

(72) Inventors: Chenchen Yang, Ottawa (CA); Xu Li, Nepean (CA); Weisen Shi, Kanata (CA)

(21) Appl. No.: 19/410,196

(22) Filed: Dec. 5, 2025

Related U.S. Application Data
(63) Continuation of application No. PCT/CN2023/099110, filed on Jun. 8, 2023.

(51) Int. Cl. H04W 48/18

(52) U.S. Cl. CPC H04W 48/18

(57) ABSTRACT

The present application relates to systems and methods for initial access. In an example method, a radio access network (RAN) receives an access request message from a terminal device, the access request message includes at least one requested mission identifier (ID), the at least one requested mission ID indicating at least one requested mission, the RAN determines at least one allowed mission from the at least one requested mission, and the RAN sends a mission ID of the at least one allowed mission to the terminal device.

### CROSS-REFERENCE TO RELATED APPLICATION

This application is a continuation of International Application No. PCT/CN2023/099110, filed on Jun. 8, 2023, the disclosure of which is hereby incorporated by reference in its entirety.

### TECHNICAL FIELD

The present disclosure pertains to the field of communication networks, and in particular to methods and systems for management function selection.

### BACKGROUND

X-centric network is proposed for 6G to provide X as a service (XaaS). In specific, the XaaS can be Data Analytics and Management (DAM) as a service in which X represents data analytics and management, network for artificial intelligence (NET4AI) as a service, network for data (NET4Data) as a service, etc. These services may cooperate together to complete a mission. For example, in a mission of optimizing the network performance, the DAM service may collect useful data from data source, then store the collected data into the storage of NET4Data service, and the NET4AI service use the collected data to perform AI training or AI inference to obtain a trained model or inference result, then the trained model or inference result is used to run the virtual network of the physical network to verify whether the trained model or the inference result is meaning for optimizing the network performance, at last the verified model or inference result can be deployed into the physical network. The mission based scheme will be used in 6G to manage the cooperation of the different services. A mission needs the involvement of different services, and each service can be regarded as a task. That is, a mission consists of a number of tasks, and the tasks cooperate and work in sequence or in parallel to complete a mission. In some cases, a mission may consist of a number of sub-missions and/or tasks, and a sub-mission consists of a number of tasks. In the previous prior art, the details of processing the mission are not provided. Specifically, when processing a mission, how to select management function is not discussed.

### SUMMARY

An object of embodiments of the present disclosure is to provide methods and systems for management function selection.

A first aspect of the disclosure provides a method of management function selection. The method comprises: sending, by an first mission management function, registration request message, the registration request message indicates one or more missions supported by the initial mission management function or one or more submissions supported by the initial mission management function; receiving, by the first mission management function, a first request message, the first request message indicates a requested mission; determining, by the first mission management function, one or more target mission management functions, wherein the one or more target mission functions are capable of providing the requested mission or one or more submissions involved in the requested mission; selecting, by at least the first mission management function, a second management function from the first mission function and the one or more target mission management function.

In some embodiments of the first aspect of the disclosure, determining, by the first mission management function, one or more target mission management functions comprising: determining, by the first mission management function, whether the one or more target mission management functions capable of providing the requested mission exist in network.

In some embodiments of the first aspect of the disclosure, determining, by the first mission management function, the one or more target mission managements capable of providing the requested mission do not exist in the network, the method further comprising: sending, by the first management function, a discovery message, the discover message indicates the one or more submissions involved in the requested mission.

In some embodiments of the first aspect of the disclosure, the method further comprising: receiving, by the first management function, one or more target mission management function IDs indicating the one or more target mission management functions, the one or more target management functions are capable of providing the requested mission.

In some embodiments of the first aspect of the disclosure, the method further comprising: receiving, by the first management function, one or more candidate mission management function IDs indicating the one or more candidate mission management functions, the one or more candidate management functions are capable of providing the one or more submissions involved in the requested mission; sending, by the first management function, second request message to the one or more candidate mission management functions; receiving, by the first management function, one or more response messages from the one or more candidate mission management functions; and determining, by the initial management function, the one or more target mission management functions from the one or more candidate mission management functions based on the one or more response messages.

In some embodiments of the first aspect of the disclosure, the registration request message includes at least one of: Mission ID, mission context, submission ID and submission context, the mission ID indicates the mission supported by the first mission management function, the mission context is for describing the mission supported by the first mission management function, the submission ID indicates the submission supported by the first mission management function, the submission context is for describing the submission supported by the first mission management function.

In some embodiments of the first aspect of the disclosure, the second request message includes at least one of: mission ID indicating the requested mission, mission context describing the requested mission, submission ID indicating submission involved in the requested mission, submission context describing the submission separated from the requested mission.

A second aspect of the disclosure provides an apparatus, the apparatus comprises a processor, the processor is configured to execute instructions stored in memory, when the instructions is executed by the processor, the method of the first aspect is performed.

A third aspect of the disclosure provides a computer-readable storage medium, comprising instructions which, when executed by a computer, cause the computer to carry out the methods of the first aspect.

Another object of embodiments of the present disclosure is to provide initial access methods and systems.

A fourth aspect of the disclosure provides a method of management function selection. The method comprises: receiving, by a radio access network (RAN), an access request message from a terminal device, the access request message includes at least one requested mission ID, the requested mission ID indicating at least one requested mission; determining, by the RAN, at least one allowed mission from the at least one requested mission; sending, by the RAN, mission ID of the at least one allowed mission to the terminal device.

In some embodiments of the fourth aspect of the disclosure, the determining, by the RAN, allowed mission ID from the requested mission ID comprising: determining, by the RAN, whether there's overlap between supported mission ID and the at least one requested mission ID, the supported mission ID indicates mission supported by management function of the RAN and/or core network (CN); selecting, by the RAN, the overlapped mission ID as the allowed mission ID.

In some embodiments of the fourth aspect of the disclosure, the determining, by the RAN, allowed mission ID from the requested mission ID comprising: sending, by the RAN, initial terminal message to core network (CN), the initial terminal message includes the requested mission ID; and receiving, by the RAN, one or more allowed mission ID of the at least one allowed mission from the CN.

In some embodiments of the fourth aspect of the disclosure, the determining, by the RAN, allowed mission ID from the requested mission ID comprising: determining, by the RAN, at least one requested mission ID does not overlap with supported mission ID, the supported mission ID indicates mission supported by management function of the RAN; or

determining, by the RAN, at least one requested mission ID is not supported by the RAN in a cell, a tracking area, or a network the terminal device requests to access; sending, by the RAN, initial terminal message to core network (CN), the initial terminal message includes the requested mission ID; and receiving, by the RAN, one or more allowed mission ID of the at least one allowed mission from the CN.

In some embodiments of the fourth aspect of the disclosure, the determining, by the RAN, allowed mission ID from the at least one requested mission ID comprising: determining, by the RAN, at least one overlapped mission ID between the at least one requested mission ID and at least one supported mission ID, the at least one supported mission ID indicates at least one mission supported by at least one mission management function of the RAN;
sending, by the RAN, initial terminal message to core network (CN), the initial terminal message includes the at least one overlapped mission ID; and
receiving, by the RAN, one or more allowed mission ID of the at least one allowed mission from the CN.

In some embodiments of the fourth aspect of the disclosure, the determining, by the RAN, the at least one overlapped mission ID further comprising:
determining, by the RAN, the at least one overlapped mission ID is supported by the RAN in a cell, a tracking area, or a network the terminal device requests to access.

In some embodiments of the fourth aspect of the disclosure, the determining, by the RAN, allowed mission ID from the at least one requested mission ID comprising:
determining, by the RAN, at least one overlapped mission ID between the at least one requested mission ID and at least one supported mission ID, the at least one supported mission ID indicates at least one mission supported by at least one mission management function of the RAN; and,
determining, by the RAN, one or more of the at least one requested mission ID does not overlap with any at least one supported mission ID, the at least one supported mission ID indicates at least one mission supported by at least one mission management function of the RAN; or,
determining, by the RAN, one or more of the at least one requested mission ID is not supported by the RAN in a cell, a tracking area, or a network the terminal device requests to access;
sending, by the RAN, initial terminal message to core network (CN), the initial terminal message includes the at least one overlapped mission ID and the one or more of the at least one requested mission ID; and
receiving, by the RAN, one or more allowed mission ID of the at least one allowed mission from the CN.

In some embodiments of the fourth aspect of the disclosure, the initial terminal message further includes one or more of: terminal device context and RAN capability.

In some embodiments of the fourth aspect of the disclosure, the UE context includes one or more of: a cell ID identifying the cell the terminal device is located in, a tracking area ID identifying the tracking area the terminal device is located in, a public land mobile network (PLMN) ID identifying the public network the terminal device is located in or requesting to access, a non-public network (NPN) ID identifying the non-public network the terminal device is located in or requesting to access, and terminal device's computing and communication ability on executing the mission.

In some embodiments of the fourth aspect of the disclosure, the RAN capability includes one or more of: supported Mission ID of the RAN, supported Task ID of the RAN, and supported submission ID of the RAN.

In some embodiments of the fourth aspect of the disclosure, the receiving, by a radio access network (RAN), an access request message from a terminal device comprising:

sending, by the radio access network (RAN), at least one supported mission ID to the terminal device, before the RAN receiving the access request message.

In some embodiments of the fourth aspect of the disclosure, the method further comprising: sending, by the radio access network (RAN), the at least one supported mission ID together with one or more of: a cell ID, a network ID, and a tracking area ID.

The sending, by the radio access network (RAN), at least one supported mission ID to the terminal device comprising:

In some embodiments of the fourth aspect of the disclosure, the sending, by the RAN to the terminal device via one or more of: a broadcast message, a unicast message, a system information, a radio resource control (RRC) message, a paging message, and a dedicated signaling message to the terminal device.

In some embodiments of the fourth aspect of the disclosure, the method further comprising: receiving, by the RAN, mission data plane establishment request message from the terminal device, the mission data plane establishment request is for requesting establishment of mission data plane for a first requested mission, the first requested mission is one of the missions indicated by the at least one allowed mission ID.

In some embodiments of the fourth aspect of the disclosure, the method further comprising: determining, by the RAN, the RAN can execute the first requested mission by itself; and responding, by the RAN, to the terminal device for the successful establishment of mission data plane.

In some embodiments of the fourth aspect of the disclosure, the method further comprising: determining, by the RAN, the RAN can't execute the first requested mission by itself; and sending, by the RAN, the mission data plane establishment request message to core network (CN); receiving, by the RAN, mission data plane establishment response message, the mission data plane establishment response message includes at least one of: mission ID of the first requested mission, a submission ID identifying submission which is involved in the first requested mission and to be provided by the RAN, a task ID identifying task which is involved in the first requested mission and to be provided by the RAN, a mission session ID identifying the mission data plane, and mission context including an indication on whether RAN should be involved in the mission data plane; and responding, by the RAN, to the terminal device for the successful establishment of mission data plane.

In some embodiments of the fourth aspect of the disclosure, the responding, by the RAN, to the terminal device for the successful establishment of mission data plane comprises: responding, by the RAN to the terminal device, one or more of: mission ID of the first requested mission, a submission ID identifying submission to be provided by the terminal device which is involved in the first requested mission, a task ID identifying task which is involved in the first requested mission and to be provided by the terminal device, a mission session ID identifying the mission data plane, and mission context including an indication on whether the terminal device should be involved in the mission data plane, a radio bearer ID, and configuration parameter on a radio bearer identified by a radio bearer ID.

A fifth aspect of the disclosure provides an apparatus, the apparatus comprises a processor, the processor is configured to execute instructions stored in memory, when the instructions is executed by the processor, the method of the fourth aspect is performed.

A sixth aspect of the disclosure provides a computer-readable storage medium, comprising instructions which, when executed by a computer, cause the computer to carry out the methods of the fourth aspect.

A seventh aspect of the disclosure provides an initial access method, comprising: receiving, by a radio access network (RAN), an establishment require message from CN, the establishment request message is for requesting establishment of mission data plane for a first request mission requested by a network function (NF) or an application function (AF); and responding, by the RAN, to the CN an establishment response message for the successful establishment of mission data plane.

In some embodiments of the seventh aspect of the disclosure, the establishment request message includes at least one of: mission ID of the first requested mission, a submission ID identifying submission which is involved in the first requested mission and to be provided by the RAN side, a task ID identifying task which is involved in the first requested mission and to be provided by the RAN side, a mission session ID identifying the mission data plane, and mission context including an indication on whether RAN should be involved in the mission data plane.

In some embodiments of the seventh aspect of the disclosure, the method further comprising: requesting, by the RAN, to one or more terminal devices for the establishment of the mission data plane.

In some embodiments of the seventh aspect of the disclosure, the requesting, by the RAN, to one or more terminal devices for the establishment of the mission data plane comprises: determining, by the RAN, terminal device is to be involved in the mission; selecting, by the RAN, the one or more terminal devices.

In some embodiments of the seventh aspect of the disclosure, the requesting, by the RAN, to one or more terminal devices for the establishment of the mission data plane, comprises: sending, by the RAN to the terminal device, at least one of: mission ID of the first requested mission, a submission ID identifying submission to be provided by the terminal device which is involved in the first requested mission, a task ID identifying task which is involved in the first requested mission and to be provided by the terminal device, a mission session ID identifying the mission data plane, and mission context including an indication on whether the terminal device should be involved in the mission data plane, a radio bearer ID, and configuration parameter on a radio bearer identified by a radio bearer ID.

In some embodiments of the seventh aspect of the disclosure, before the requesting, the method further comprises: receiving, by the RAN, a report message from the terminal device; and the report message includes one or more of: a supported mission ID identifying a mission which is supported to be executed by the terminal device, a submission ID identifying a submission which is supported to be executed by the terminal device, a task ID identifying a task which is supported to be executed by the terminal device, and UE's computing and communication ability on executing the mission.

An eighth aspect of the disclosure provides an apparatus, the apparatus comprises a processor, the processor is configured to execute instructions stored in memory, when the instructions is executed by the processor, the method of the seventh aspect is performed.

A ninth aspect of the disclosure provides a computer-readable storage medium, comprising instructions which, when executed by a computer, cause the computer to carry out the methods of the seventh aspect.

### BRIEF DESCRIPTION OF THE DRAWINGS

Further features and advantages of the present disclosure will become apparent from the following detailed description, taken in combination with the appended drawings, in which:

FIG. 1 depicts a mission graph, according to embodiments.

FIG. 2 depicts physical mission instance corresponding to FIG. 1, according to embodiments.

FIG. 3 depicts a block diagram of an optional system architecture, according to embodiments.

FIG. 4 depicts a workflow of a processing function selection method, according to embodiments.

FIG. 5A depicts a block diagram of MM without hierarchy, according to embodiments.

FIG. 5B depicts a mission graph corresponding to FIG. 5A, according to embodiments.

FIG. 6 depicts a workflow of another processing function selection method, according to embodiments.

FIG. 7 depicts a workflow of another processing function selection method, according to embodiments.

FIG. 8 depicts a workflow of another processing function selection method, according to embodiments.

FIG. 9 depicts a workflow of another processing function selection method, according to embodiments.

FIG. 10 depicts a workflow of a selection method for mission instantiation, according to embodiments.

FIG. 11 depicts a workflow of an initial access method, according to embodiments.

FIG. 12 depicts a workflow of another initial access method, according to embodiments.

FIG. 13 shows the corresponding system architecture corresponding to FIG. 10.

FIG. 14 shows the corresponding system architecture corresponding to FIG. 11.

FIG. 15 shows the corresponding system architecture corresponding to FIG. 12.

It will be noted that throughout the appended drawings, like features are identified by like reference numerals.

### DETAILED DESCRIPTION OF ILLUSTRATIVE EMBODIMENTS

As used herein, the term “anything-as-a-service,” i.e. “XaaS” can reflect the concept as it has been proposed in the computer networking industry. For example, XaaS can be conceptualized as a generalization of software-as-a-service or infrastructure-as-a-service concepts. XaaS can leverage cloud computing and device virtualization concepts, coupled with a service model to deliver a variety of functionalities. According to embodiments of the present disclosure, XaaS can describe for example that the functionality of an arbitrary module disclosed herein can be provided as a service to another module or an external entity, such as a customer. The phrase “as service” is used herein to be synonymous with “as a service.” As illustrated in the background, a mission needs the involvement of different services, and each service is regarded as a task. In a processing cycle of a mission, there are multiple phases including a mission development phase, a mission deployment phase, a mission execution phase.

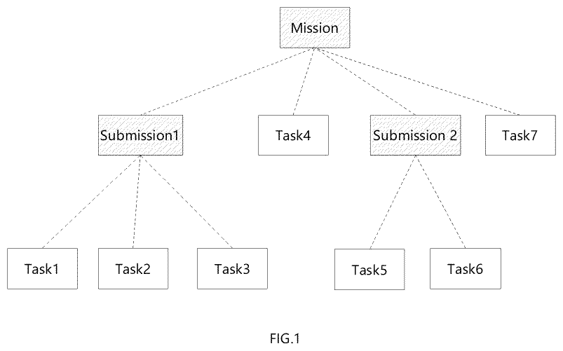

In the mission development phase (e.g., mission provisioning), the mission graph (Task level) is developed to indicate the composition of a mission. For example, as in FIG. 1, a mission consists of Submission 1 (including Task 1-3), Task 4, Submission 2 (including Task 5-6), Task 4, in sequence. At the same time, the sequential or parallel workflows of the consisted submissions and tasks are also indicated in the mission graph. The mission graph indicates the service chain of the consisted submissions and tasks.

In the mission deployment phase following the mission development phase, the mission graph (task level) is mapped to a physical mission instance (entity level). The physical mission instance can consist of one or more available entities who have the ability to execute one or more tasks involved in the mission. For example, the available entity can be a service module consisting of controller and processing function (PF). The service module can be referred as XaaS module, the controller can be referred as XaaS controller (XC). Each physical mission instance can be regarded as a mission slice.

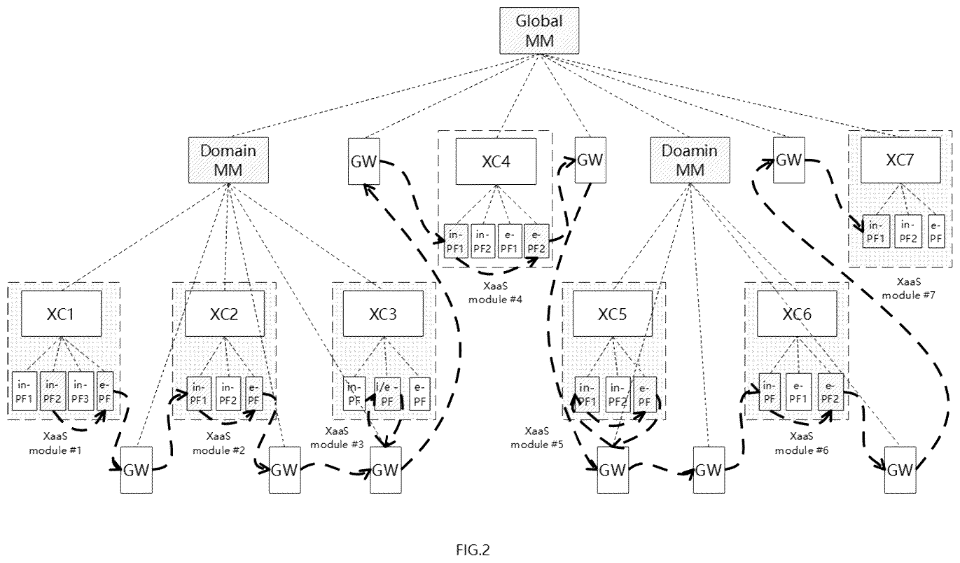

For example, as in FIG. 2, corresponding to the mission graph in FIG. 1, to instantiate the mission, the Task 1-Task 3 of the mission are respectively instantiated to XaaS module 1 (including XC1, three ingress PFs and one egress PF, namely, in-PF1, in-PF2, in-PF3 and e-PF), XaaS module 2 (including XC2, two ingress PFs and one egress PF, namely, in-PF1, in-PF2, and e-PF), XaaS module 3 (including XC3, two ingress PFs and two egress PFs, namely, in-PF, e-PF, and i/e-PF, wherein the i/e PF is both a ingress PF and a egress PF), XaaS module 4 (including XC4, two ingress PFs and two egress PFs, namely, in-PF1, in-PF2, e-PF1 and e-PF2), XaaS module 5 (including XC5, two ingress PFs and one egress PF, namely, in-PF1, in-PF2 and e-PF), XaaS module 6 (including XC6, two ingress PFs and one egress PF, namely, in-PF1, in-PF2 and e-PF), XaaS module 7 (including XC7, two ingress PFs and one egress PF, namely, in-PF1, in-PF2 and e-PF). The dashed arrowed lines indicate mission workflow. Each task is instantiated to a task slice consisting of XC and a number of PFs. Besides the ingress PFs and egress PFs (we call the ingress PF and the egress PF as boarder PFs), there may be intermediate PFs in a XaaS module to perform data processing (the intermediate PFs are not reflected in FIG. 2). We consider the intermediate PFs depends on implementation of the XaaS module and not discussed in this application. The ingress PF is to receive input data from external entity (e.g., from an egress PF of a XaaS module), and the egress PF is to output the processed data to external entity (e.g., to an ingress PF of a XaaS module). The ingress PF and egress PF of a Xaas module may be a same PF.

In the mission execution phase following the mission deployment phase, when a mission is to be executed, e.g., on the request of a UE, an application function (AF), a network function (NF), or the management plane, control plane (e.g., mission management (MM) function, XC) discovers, selects, connects and configures the PFs of the mission instance for establishing a specific data plane of the mission. The NF includes connectivity management (CM) function, resource management (RM) function, e.g., for location based multiple access (LOMA), etc. Suitable PFs of the mission instance should be selected by control plane considering communication (e.g., data forwarding) and computing (e.g., data processing) cost. Note that, the suitable PFs to be involved in a mission is selected when the mission is to be executed, but we do not rule out that the suitable PFs to be involved in a mission is selected when the mission is instantiated. As in FIG. 2, one ingress PF and one egress PF of each XaaS module are selected, and control plane configures them to setup the connections between them to establish the mission data plane, and the PFs of two XaaS modules may be interconnected via one or multiple gate ways (GWs).

As in FIG. 2, different XaaS modules may connect to the same GW or different GWs, the ingress and egress PFs of a XaaS module may connect to the same GW or different GWs. Some GWs are under the control of Domain MM, and others are under the control of Global MM. Global and domain DAM cooperate to provide service. For example, The global MM is in charge of a whole mission, and coordinates the domain MM, the domain MM is in charge of submissions or tasks. The ingress PF and egress PF of a XaaS module may be integrated (i.e., the integrated PF e.g., the i/e-PF of XaaS module 3).

In previous work, the following questions are not answered: When instantiate a mission slice, or establish a mission data plane, how can MM get the network topology, i.e., how can MM discover the candidate boarder PFs and GWs to be involved in a mission instance, or a mission plane. How can MM select specific ingress PFs, egress PFs, and GWs when the mission is instantiated, or when the mission data plane is established. There are multiple distributed MMs in the MM hierarchy, how to determine which MM is to be the Global MM or Domain MM. The present application provides methods and systems of mission management aiming to solve one or more above questions.

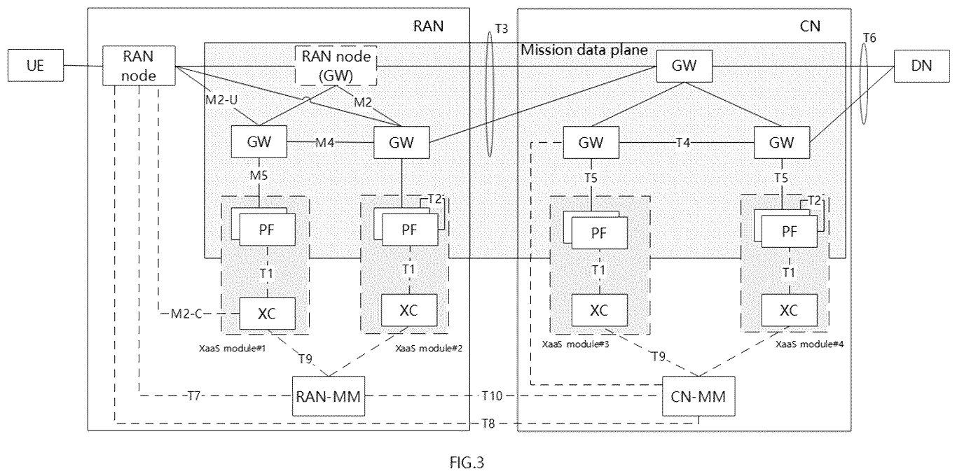

FIG. 3 shows a block diagram of an embodiment of an optional system architecture the present disclosure can be applicable. As in FIG. 3, the system architecture includes radio access network (RAN), core network (CN) and user equipment (UE). The XaaS modules are deployed in RAN side and CN side.

The MMs are deployed with MM hierarchy. For example, there are global MM and domain MM. The hierarchy may be due to Mission hierarchy (e.g., mission under the control of global MM, and submission under the control of domain MM), or due to network Administration hierarchy (e.g., RAN and CN). A domain refers to an administrative domain or a mission management domain. For example, there are MMs deployed in RAN and CN respectively, i.e., RAN-MM and CN-MM. The global MM and the domain MM can be located in the same network domain or different network domains. For example, both the two MMs are located in CN, i.e., CN-MMs, or both located in RAN, i.e., RAN-MMs, or one is located in RAN while the other one is located in CN. The RAN-MMs can be domain MMs and the CN-MMs can be global MMs, or the RAN-MMs can be global MMs and the CN-MMs can be domain MMs.

In each XaaS module, there are one XC and one or more PFs. XC connects with PF via T1 interface. Some PFs of a XaaS module are boarder PFs (e.g., ingress PFs, egress PFs) to connect external entities.

GWs on data plane may be deployed in RAN and CN. RAN-GW connects to RAN-PF via M5 interface, to RAN-GW via M4 interface, to RAN node via M2 interface, to CN-GW via T3 interface. CN-GW connects to CN-PF via T5 interface, to CN-GW via T4 interface, to DN via T6 interface. Integrated or split RAN node can be deployed.

If integrated RAN node is deployed (e.g., there is no CU or DU deployed): RAN node connects to XC via M2-C interface, to GW via M2-U interface, to PF via M2-U and M5 interfaces, to RAN-MM via T7 interface, to CN-MM via T8 interface, to CN-GW via T3 interface, and to UE via radio link.

If split RAN node is deployed (e.g., there are CU and DU deployed): a splitted part (e.g., DU) of RAN node connects to XC via M2-C interface, to GW via M2-U interface, to PF via M2-U and M5 interfaces, and to UE via radio link; another part (e.g., CU) of RAN node connects to XC via M2-C interface, to GW via M2-U interface, to PF via M2-U and M5 interfaces, to RAN-MM via T7 interface, to CN-MM via T8 interface, to CN-GW via T3 interface.

The RAN-GW can connect to CN-GW directly via T3 interface, or intermediately via RAN node. GWs are optionally deployed, for example, when GWs are not deployed in RAN. The RAN node can connect to CN-GW directly via T3 interface.

The PFs (i.e., boarder PFs and intermediate PFs) within a XaaS module intra-connect via T2 interface, and PFs (i.e., boarder PFs) deployed in different XaaS module inter-connect via GW(s) or directly. For example, On CN side, PFs deployed in different XaaS module can connect with each other via GW(s). On RAN sider, PFs deployed in different XaaS module connect with each other via T2 interface directly, but we do not rule out that RAN-PFs deployed in different XaaS module can connect with each other via GW.

The RAN-PF can connect to CN-GW via the intermediate M5 and T3 interfaces, or via the intermediate M5, M2 and T3 interfaces. If the GWs are not deployed in RAN, the RAN-PF can connect to CN-GW directly, or via the intermediate RAN node.

### MM Connects to XC Via T9 Interface.

Hierarchical MMs connect with each other via T10 interface directly or via intermediate entity. For example, Hierarchical MMs in the same domain (e.g., both in CN) can connect with each other via T10 interface directly via SBI interface; Hierarchical MMs in the same domain (e.g., both in RAN) can connect with each other via RAN node. Hierarchical MMs in the same domain (e.g., both in CN) can connect with each other directly or via a network function (e.g., a CM). Hierarchical MMs in the different domains (e.g., RAN-MM and CN-MM) can connect with each other via RAN node (i.e., via the intermediate T8 and Ty interfaces), or directly via T10 interface.

Some of the entities above can be integrated, e.g., RAN node and XaaS modules on RAN side can be integrated.

The UE in the present application is a kind of a terminal device, the terminal device may be a device providing data connectivity for a user, a handheld device having a wireless connection function, or a wireless device. A terminal device may communicate with one or more CNs through RAN. The terminal device may be a mobile terminal, such as a mobile phone (also referred to as a “cellular” phone) or a computer with a mobile terminal, for example, may be a portable, pocket-sized, handheld, computer built-in, or in-vehicle mobile apparatus, which exchanges voice and/or data with the radio access network. For example, the terminal device may be a device such as a personal communication service (PCS) phone, a cordless telephone set, a Session Initiation Protocol (SIP) phone, a wireless local loop (WLL) station, or a personal digital assistant (PDA). The terminal device may also be referred to as a subscriber unit, a subscriber station, a mobile station, a remote station, an access point, a remote terminal, an access terminal, a user terminal, a user agent, user device, or UE, a smartphone, an automotive device, or an Internet of Things device (IoT Device).

The RAN may be a form of a radio station, and is a radio transceiver station that transfers information with a mobile phone terminal in a particular radio coverage area by using a mobile communication switching center, or may be a device that communicates with a terminal device over an air interface in an access network by using one or more sectors. The RAN may be configured to perform mutual conversion between a received over-the-air frame and an Internet Protocol (IP) packet, and serve as a router between the terminal device and a remaining part of the access network. The remaining part of the access network may include an Internet Protocol (IP) network. The RAN may further coordinate attribute management on the air interface. For example, the RAN may be a base station, such as any one of a base transceiver station (BTS), a NodeB, an evolved NodeB (eNB), and the like. No limitation is imposed in this application.

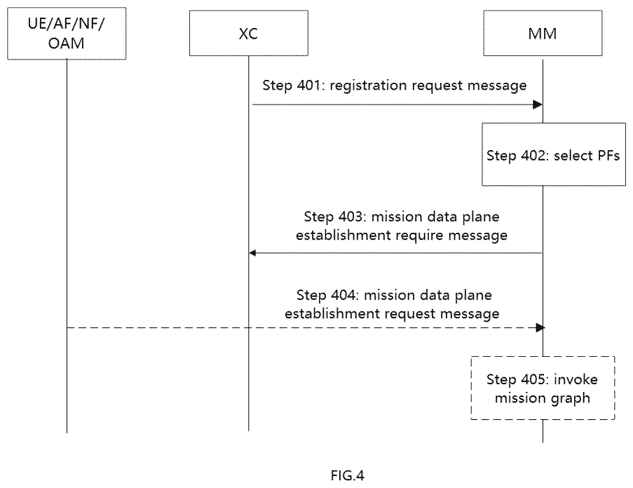

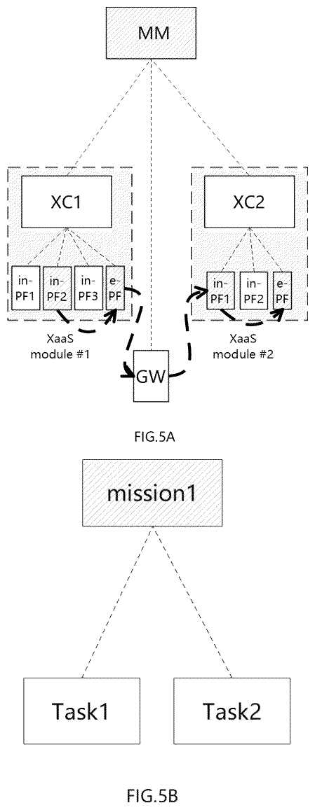

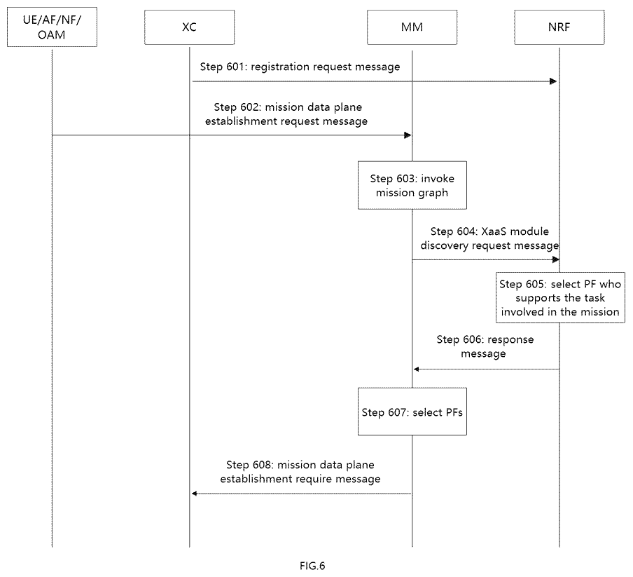

The present application provides a processing function selection method. FIG. 4 shows an embodiment of a workflow of a processing function selection method in accordance with the present disclosure. FIG. 5A shows an embodiment of MM without hierarchy, FIG. 5B shows an embodiment of mission graph corresponding to FIG. 5A. Referring to FIG. 4, FIG. 5A and FIG. 5B, the method comprising:

Step 401: a mission management (MM) function obtains a list of processing function identifiers (PF IDs) from a service controller, the list of PF IDs includes one or more PF IDs, each of the PF IDs is used to indicate one PF respectively, each of the PFs connects to one service controller.

Referring to FIG. 5A, in Xaas module 1, the in-PF1, in-PF2, e-PF1 and e-PF2 connect to the service controller XC1, in Xaas module 2, the in-PF1, in-PF2 and e-PF connect to the service controller XC2.

In some embodiments, the list of PF IDs is carried on a registration request message, the registration request message is sent from the service controller. Referring to FIG. 4, the XC1 send a registration request message to the MM, the registration request message includes the list of PF IDs, the list of PF IDs includes at least one of: an ID of the in-PF1, an ID of the in-PF2, an ID of the e-PF1 and an ID of the e-PF2. It can be understood that the present application is not limited to multiple XaaS modules, there may be only one XaaS module, for example, only XaaS module 1 sends the list of PF IDs to the MM. When there are more than one Xaas modules, each of the XC can send the registration request message separately. For example, the XC2 sends another registration request message to the MM, the registration request message sent from the XC includes a list of PF IDs, the list of the PF IDs includes at least one of: an ID of the in-PF1 in XaaS module 2, an ID of the in-PF2 and an ID of the e-PF.

In some embodiments, the MM further obtains processing function attribute corresponding to the PFs. The processing function attribute can be included in the registration request message. The PF attribute includes the PF type (e.g., ingress PF, egress PF) of each of the PFs, the supported task IDs by each of the PFs, the location (e.g., cell, network, tracking area, geographical area) of each of the PFs, the capability (e.g., data processing capability, computing capability, and communication capability) of each of the PFs, the supported input and the output data format of each of the PFs. Also referring to FIG. 5A, the PF attribute corresponding to XaaS module 1 comprises: the type of each of the four PFs, the supported task IDs of each of the four PFs, the location of each of the four PFs, and the capability (e.g., data processing capability, computing capability, and communication capability) of each of the four PFs. The supported task IDs comprise the IDs of the tasks that each of the four PFs are able to execute. For example, the supported tasks IDs include the ID of the task 1. The PF attribute can be included in the registration request message. The PF attribute corresponding to XaaS module 2 comprises: the type of each of the three PFs, the supported task IDs of each of the three PFs, the location of each of the three PFs, and the capability of each of the three PFs. The supported task IDs comprise the IDs of the tasks that each of the three PFs are able to execute. For example, the supported tasks IDs include the ID of the task 2. The PF attribute can be included in the registration request message. The registration request message may further include the ID of the XC, for example, the registration request message sent from the XC1 includes the ID of the XC1 which can be written as XC ID1. It should be noted that, FIG. 5A and FIG. 5B show a mapping relationship between the XC and the task, e.g., the XC1 supports the task 1, and the XC2 supports the task 2. In fact, the MM can control more than these two XCs, for example, the MM further controls the XC3 and XC4, the XC3 and the XC4 can also send the registration request message to the MM and provide the list of the PF IDs to the MM, the XC3 and XC4 may not support the task 1 and the task2. The MM can know the information about which XC supports which task, and determines that a specific XC executes a specific task. For example, the MM determine that the XC1 executes the task 1 and the XC2 executes the task 2 based on the information received from the XC1 to XC4.

Step 402: the MM selects one or more selected PFs from the PFs in the list. In step 402, when the MM receives the list of PFs from each of the XCs, the MM can select an ingress PF and an egress PF for the XC. Referring to FIG. 5A and FIG. 5B, the XC1 and XC2 send the lists of the PFs separately, the MM select the in-PF2 and e-PF in the XaaS module 1 for the XC1, and the MM select the in-PF1 and e-PF in the XaaS module 2 for the XC2, then the in-PF2 and e-PF in the XaaS module 1 can be involved in the procedure of processing the task 1, the in-PF1 and e-PF in the XaaS module 2 can be involved in the procedure of processing the task 2.

Step 403: the MM sends one or more PF IDs of the one or more selected PFs to the service controller. In step 403, when the MM selected the PFs from the list, the MM sends the PF IDs of the selected PFs to the XC. For example, the MM sends the IDs of the in-PF2 and e-PF of the XaaS module 1 to the XC1, and the MM sends the IDs of the in-PF1 and e-PF of the XaaS module 2 to the XC2.

In some embodiments, the one or more PF IDs of the one or more selected PFs are carried on a message, e.g., a require message, the require message can be a mission data plane establishment require message, or a mission instantiation require message, the MM sends the message to the XC1 and XC2 separately.

In some embodiments, the MM also selects GWs to be connected to the selected PFs for the XC, the MM selects the GWs based on the attribute of each GW underneath the MM. The attribute of each GW can be obtained from control plane functions including the XC or other functions, the attribute of GW comprises GW load or GW location. Considering communication (e.g., data forwarding) and computing (e.g., data processing) efficiency, the MM selects the boarder PFs and GWs jointly.

In some embodiments, the message, e.g., mission data plane establishment require message, or mission instantiation require message further includes at least one of: the mission ID, the task ID, and the selected GWs corresponding to the selected PFs. And each XC configure the selected PFs to establish the connection with the selected GW. The selected GW is configured by the MM to establish the connection with the selected PFs. When the MM send the mission data plane establishment require message to XC1, the mission ID is the ID of mission 1, the task ID is the ID of task 1. When the MM send the mission data plane establishment require message to XC2, the mission ID is the ID of mission 1, the task ID is the ID of task 2.

In some embodiments, the method further comprises step 404 and step 405.

Step 404: the MM receives a message, e.g., a request message, the request message can be a mission data plane establishment request message, or a mission instantiation request message from a UE, an AF, a NF, or a management plane (e.g., operations, administration and maintenance (OAM)), and a mission ID is included in the message. The NF includes connectivity management function (CM), resource management function (RM), e.g., for location based multiple access (LOMA), etc. Taking the FIG. 5A and FIG. 5B as an example, the mission ID is the ID of mission 1. The mission 1 can be split into multiple tasks, such as: task 1 and task 2, each task is identified by a task ID uniquely, e.g., task ID1 and task ID2.

Step 405: the MM invokes the Mission graph or the Mission instance information (e.g., invokes Mission graph in Mission instantiation phase, and invokes Mission instance information in mission data plane establishment phase) corresponding to the Mission ID from local storage or from Mission data Repository (MDR), the Mission graph or the Mission instance information indicates the tasks involved in the mission, and each task is identified by a task ID. The MM obtains the task IDs based on the mission graph or mission instance information and the mission ID obtained from the UE, the AF, the NF, or the management plane. As an example, the task IDs comprises the ID of task 1 and the ID of task 2 in FIG. 5B, namely the task ID1 and the task ID2. The steps 404 and 405 can be before any one or more of the steps 401-403, or the steps 404 and 405 can be behind any one or more of the steps 401-403. In some embodiments, the sequence of these steps can be: step 401, step 404, step 405, step 402 and step 403.

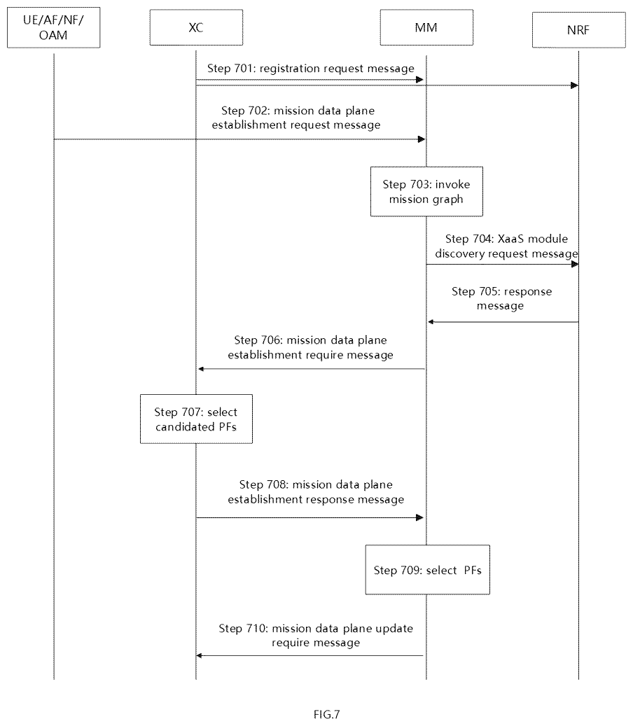

FIG. 6 shows another embodiment of a workflow of a processing function selection method in accordance with the present disclosure. The embodiment of FIG. 6 is similar with the embodiment of FIG. 4, the difference between the FIG. 4 and the FIG. 6 is that in FIG. 4 the XC registers to MM directly, in FIG. 6 the XC registers to a network function (e.g., a network repository function (NRF)), the similar details between the FIG. 4 and FIG. 6 will not be illustrated specifically, the method comprising:

Step 601: service controller sends a registration request message to a network function (e.g., a network repository function (NRF)), the service controller can be XC1 in FIG. 5A. The registration request message includes a list of PF IDs, the PF IDs comprises the IDs of the PFs connecting to the XC1. For example, the list of PF IDs includes at least one of: an ID of the in-PF1, an ID of the in-PF2, an ID of the in-PF3 and an ID of the e-PF. Optionally, the list of the PF IDs sent by the XC1 to the network function (e.g., NRF) includes the IDs of all the PFs connected to the XC1. Same as the step 401, more than one service controller can send the registration request message to the MM, for example, a part of or all the service controllers controlled by the MM can send the registration request message to the MM. The network function in the application supports to maintain the profile of other available network functions (e.g., MM) in the network and supports service discovery, supports to receive network function discovery request from a network function, and to provide the information of the discovered network function (be discovered) to the network function (sending the discovery request). The network function can be deployed in CN or RAN. The network function could be an existing 5G network function, e.g., Network repository function (NRF) or other existing network functions, or could be a new defined 6G network function. The following steps are described using an example where the network function is an NRF.

In some embodiment, the registration request message further includes processing function attribute corresponding to the PFs, the details of the processing function attribute can be referred to Step 401. The registration request message further includes ID of the XC, such as the ID of the XC1. For example, as in FIG. 5A and FIG. 5B, XC1 sends to the network function (e.g., NRF) the list of PF IDs including the PF ID of each of its connected four PFs, the supported task IDs of each of its connected four PFs, and the XC ID of the XC1. XC2 sends to the network function (e.g., NRF) the list of PF IDs including the PF ID of each of its connected three PFs, the supported task IDs of each of its connected three PFs, and the XC ID of the XC2.

Step 602: the MM receives a message, e.g., a request message, the request message can be a mission data plane establishment request message from a UE, an AF, a NF, or a management plane. The details in step 602 can be referred to step 404.

Step 603: the MM invokes the Mission graph or the Mission instance information.

The details in step 603 can be referred to step 405. As an example, MM invokes the mission graph or mission instance information which indicates that the mission needs the involvement of task 1 (identified by task ID1) and task 2 (identified by task ID2).

Step 604: the MM sends the task IDs (e.g., task ID1 and task ID2) obtained from step 603 to the network function (e.g., NRF), the task IDs can be included in a message, e.g., a XaaS module discovery request message.

Step 605: The NRF selected the PFs (from the list of PFs received in Step 601) whose supported task IDs are all or parts of overlapped with the task ID1 or task ID2 received in Step 604. For example, the in-PF1, in-PF2 and e-PF of XaaS module 1 at least support the task 1, the in-PF3 does not support the task 1 and task 2, the NRF will select the in-PF1, in-PF2 and e-PF from the list of the PFs and sends these selected PF IDs to the MM. In other words, the NRF receives task IDs (task 1 and task 2) from the MM, and the NRF receives the list of PF IDs of each of one or more service controllers controlled by the MM, and the supported task IDs of these PFs, then the NRF can know which PFs supports the task 1 and which PFs support the task 2, and the NRF will send this information to the MM, so if a PF supports neither task 1 nor task 2, this PF will not be selected by the NRF, NRF will not send the information of this PF to the MM.

Step 606: the MM receives a response message from the NRF, the response message includes a list of PF IDs, the list of PF IDs identifies the PFs selected by the NRF in step 605, in other words, the list of PF IDs sent by the NRF to the MM is consisted of the PF IDs of the PFs selected by the NRF. For example, the PF IDs of the in-PF1, in-PF2 and e-PF of Xaas module 1 are in the list of PF IDs, the PF ID of the in-PF3 is not in the list of PF IDs.

In some embodiment, the response message further includes at least one of: the task ID(s), the XC ID(s), at the same time, the attributes of PFs are also included, and the XC ID(s) identifies the XC(s) who controls the PFs. For example, the NRF includes the PF IDs of the PFs selected by the NRF from the list of PFs connected to XC1, the overlapped task ID (e.g., task ID1), and the XC ID of the XC1 in the response message to XC1. Similarly, NRF includes the PF IDs of the PFs selected by the NRF from the list of PFs connect to XC2, the overlapped task ID (e.g., task ID2), and the XC ID of the XC2 in the response message to XC2.

Step 607: the MM selects one or more selected PFs from the PFs which are selected by the NRF before. The details in step 607 can be referred to step 402.

Step 608: the MM sends one or more PF IDs of the one or more selected PFs to the service controller. The details in step 608 can be referred to step 403.

FIG. 7 shows another embodiment of a workflow of a processing function selection method in accordance with the present disclosure. The embodiment of FIG. 7 is similar with the embodiment of FIG. 4/FIG. 6, the difference between the FIG. 4/FIG. 6 and the FIG. 7 is that in FIG. 4 the XC sends a list of PF IDs to the MM, the list of PF IDs includes a part of or all the PFs connected to the XC, the MM selects the PFs from the list, in FIG. 6, the XC sends a list of PF IDs to the network function (e.g., NRF), the list of PF IDs includes a part of or all the PFs connected to the XC, the network function (e.g., NRF) selects one or more or all the PFs in the list, and the NRF sends the PFs selected by the NRF to the MM, the MM selects PFs from the PFs selected by the NRF before. in FIG. 7, the XC determines one or more candidate PFs from a part of or all the PFs connected to the XC, the XC will send the IDs of the candidate PFs to the MM. The XC sends the list of the PF IDs in which the IDs of the candidate PFs are included to the MM directly. In the method of FIG. 7, the XC may register to the MM or the network function (e.g., NRF), when the XC registers to the MM, the XC send the list of the task IDs includes the IDs of the tasks the PFs connected to the XC are able to execute to the MM, but the PF IDs of the PFs connected to the XC are not sent, when the XC registers to the NRF, the XC send the list of task IDs includes the IDs of the tasks the PFs connected to the XC are able to execute to the NRF, the MM can obtain the list of the task IDs from the NRF, the method comprising:

Step 701: the service controller (XC) sends registration request message to MM or the network function (e.g., NRF), the registration request message includes the supported task IDs, the supported task IDs includes the IDs of the tasks the PFs connected to the service controller are able to execute. Taking FIG. 5A as an example, the PFs connected to the XC1 comprises in-PF 1, in-PF 2, in-PF 3 and e-PF, the supported task IDs may comprise the IDs of all the tasks these four PFs support to execute. Same as the step 401, a part of XCs controlled by the MM or all the XCs controlled by the MM may sends the registration request message to the MM or the NRF, then the MM or the NRF can obtain the information about the supported task IDs of each XC. The network function could be an existing 5G network function, e.g., Network repository function (NRF) or other existing network functions, or could be a new defined 6G network function. The following steps are described using an example where the network function is an NRF.

Step 702: the MM receives a message, e.g., a request message, the request message can be a mission data plane establishment request message from a UE, an AF, a NF, or a management plane. The message includes a mission ID, the mission ID for example is the ID of mission 1, The mission 1 can be split into multiple tasks, such as: task 1 and task 2, each task is identified by a task ID uniquely, e.g., task ID1 and task ID2. The details in step 702 can be referred to step 404.

Step 703: the MM invokes the Mission graph or the Mission instance information.

The details in step 703 can be referred to step 405. The MM obtains the task IDs (e.g., task ID1 and task ID2) based on the mission graph or mission instance information and the mission ID obtained from the UE, the AF, the NF, or the management plane. When the XC registers to the MM directly, the MM will decide that which XC maps which task based on the task IDs and the supported task IDs of each XC, for example, the MM decides that the XC1 maps the task 1, then the step 706 will be performed after this step. When the XC registers to the NRF, the xzinformation of the supported task IDs of each XC is obtained by the NRF, so the step 704 and step 705 will be performed.

Step 704: the MM sends the task IDs obtained from step 703 to the NRF, the task IDs can be included in a message, e.g. a XaaS module discovery request message. When the NRF receives the task IDs from the MM, the NRF will decide which XC maps to which task based on the task IDs and the supported task IDs from the XC, for example, the NRF decides that the XC1 maps the task 1. And then the NRF sends the task IDs and the XC IDs to the MM, the XC IDs identify the XCs who can provide the task identified by the task IDs.

Step 705: the MM receives a response message from the NRF, the response message includes the task IDs and XC IDs, the XC IDs identify the XCs who can provide the task identified by the task IDs. Based on the information included in the response message, the MM will be informed of the ID of XCs who can executes the tasks identified by the task IDs.

Step 706: the MM sends the mission ID and/or the task IDs to the corresponding service controller (e.g., XC1 and/or XC2), for example, the MM sends the mission ID of mission 1 and the task ID of task 1 to the XC1, the mission ID and the task IDs are used for the XC selecting the candidate PFs, the mission ID and the task IDs can be included in a message, e.g., a require message, the require message can be a mission data plane establishment require message.

Step 707: the service controller (e.g., XC1 and/or XC2) selects the candidate PFs from all the PFs the XC connected to e.g., based on the mission ID, the task IDs and the attribute of all the PFs the XC connected to. For example, the XC1 determines the in-PF1, inPF2 and e-PF can support the tasks indicated by the task IDs based on the task IDs and the attribute of the PFs, then the XC1 will select the in-PF1, inPF2 and e-PF as the candidate PFs.

Step 708: the MM receives the IDs of the candidate PFs from the XC. The IDs of the candidate PFs can be included in a response message, e.g., a mission data plane establishment response message. In some embodiments, the mission data plane establishment response message further includes at lease one of: processing function type (e.g., ingress PF, egress PF) of each of the candidate PFs, the supported task IDs of each of the candidate PFs, location (e.g., cell, network, tracking area, geographical area) of each of the candidate PFs, capability (e.g., data processing capability, computing capability, and communication capability) of each of the candidate PFs, supported input and output data format of each of the candidate PFs.

Step 709: the MM selects one or more selected PFs from the received candidate PFs. In some embodiments, the MM selects the one or more selected PFs and the GWs jointly based on the attribute of the candidate PFs and the attribute of the GWs.

Step 710: the MM sends the one or more PF IDs of the one or more selected PFs to the XC. In some embodiments, the one or more PF IDs of the one or more selected PFs are carried on a message, e.g., a mission data plane update require message.

It should be noted that in the embodiment of FIG. 7, when the XC registers to the MM, the step 704 and step 705 can be skipped.

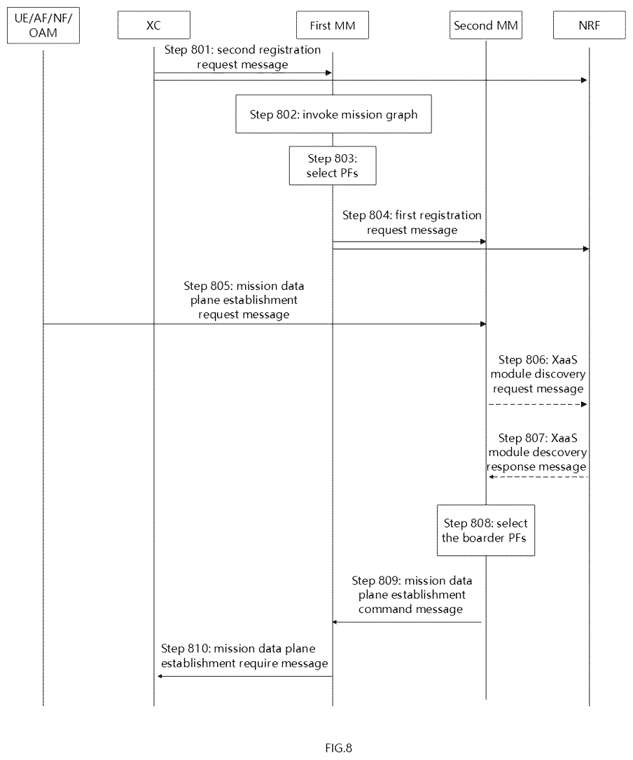

FIG. 8 shows another embodiment of a workflow of a processing function selection method in accordance with the present disclosure. The embodiment of FIG. 8 describes a processing function selection method with hierarchical MM. Referring to FIG. 1 and FIG. 2, the hierarchical MM comprises two types of MM, namely global MM and domain MM, the global MM is in charge of a whole mission, the domain MM is in charge of submission or tasks. It should be noted that the contents in the embodiments of FIG. 4 to FIG. 7 can be introduced into this embodiment. Therefore, repeated details are not described in this embodiment. The processing function selection method comprises:

Step 801: The first MM or the network function (e.g., NRF) obtain the at least one processing function IDs indicative of at least one processing functions, the at least one processing functions connected to one or more service controllers. The network function could be an existing 5G network function, e.g., Network repository function (NRF) or other existing network functions, or could be a new defined 6G network function. The following steps are described using an example where the network function is an NRF. The one or more service controller may send a second registration request message to the first MM or NRF, the second registration request message includes one or more PF IDs, the one or more PF IDs indicates at least one PFs connected to the corresponding service controller The first MM can be a domain MM. Referring to FIG. 1 and FIG. 2, the first MM can be the domain MM who is in charge of processing the submission 1 or the domain MM who is in charge of processing the submission 2. Taking the first MM is the domain MM who is in charge of processing the submission 2 as an example, the service controller can be the XC5 and/or XC6. XC5 sends a second registration request message to the domain MM, the second registration request message includes PF IDs of the PFs connected to the XC5, such as the PF IDs of in-PF1, in-PF2 and e-PF in the XaaS module 5, and XC6 may also send a second registration request message to the domain MM, the second registration request message from the XC6 comprises the PF IDs of in-PF, e-PF1 and e-PF2 in the XaaS module 6.

When the service controller registers to the first MM directly, the service controller sends the second registration request message to the first MM, the first MM obtains the PF IDs from the service controller directly. When the service controller registers to the NRF, the service controller send the second registration request message to the NRF, the first MM obtains one or more of the PF IDs from the service controller through the NRF (Referring to step 605 and 606). In some embodiments, the second registration request message further includes PF attribute, the PF attribute includes the PF type (e.g., ingress PF, egress PF) of each of the PFs, the supported task ID by each of the PFs, the location (e.g., cell, network, tracking area, geographical area) of each of the PFs, the capability (e.g., data processing capability, computing capability, and communication capability) of each of the PFs, the supported input and the output data format of each of the PFs.

Step 802: the first MM invokes submission graph or submission information (invokes submission graph in submission instantiation phase, and invokes submission information in submission data plane establishment phase) corresponding to submissions identified by submission IDs from local storage or from Mission data Repository (MDR), the submission graph or the submission information indicates the tasks involved in the submissions, and each task is identified by a task ID. The first MM obtains the task IDs based on the submission graph or the submission instance information. In this step, the first MM can obtain the submission IDs and the task IDs through invoking the submission graph, the submission IDs identify the submissions supported by the first MM, the task IDs identify the tasks involved in the submissions.

Step 803: if service controller (e.g., XC5 and/or XC6) registers to the first MM, for a specific submission the first MM supports, the first MM can determine which XC supports the tasks involved in this submission, and then the first MM will select PFs for the XC, specifically, the first MM selects one or more selected PFs from the at least one PFs whose IDs are received from the service controller (e.g., XC5 and/or XC6). If service controller (e.g., XC5 and/or XC6) registers to NRF, the first MM selects one or more selected PFs from the one or more of the PF IDs obtained from the service controller through the NRF (Referring to step 604 to 606, the first MM sends the task IDs that identify the tasks involved in the specific submission to the NRF, the NRF selects the PFs who can support the tasks based on the information received in step 801, and sends the PF IDs of these PFs to the first MM). It should be noted that the first MM can support more than one submission based on the submission graph, the first MM can obtain some task IDs identifying the tasks involved in one submission, and obtain some other task IDs identifying the tasks involved in another submission. This step and the following steps take one of the submissions supported by the first MM as example, for the other submissions the first MM supports have same procedure.

In some embodiments, when the first MM receives the PF IDs from the service controller or from the NRF, the first MM arranges the PFs in sequence based on the sequence of the tasks involved in the specific submission the MM supported, and selects one or more selected PFs based on the sequence of the PFs. Specifically, the sequence of the tasks involved in the submission can be understood as the processing sequence of the tasks. For example, when executing the submission 2, the task 5 will be executed before the task 6, then the sequence of the task will be task 5 and task 6. In some embodiments, when arranging the PFs in sequence, all the in-PFs can be sorted together, and all the e-PFs can be sorted together. Based on the sequence of the task 5 and task 6, the order of the in-PFs will be in-PF1 of XaaS module 5, in-PF2 of XaaS module 5 and in-PF of XaaS module 6, the order of the e-PFs will be e-PF of XaaS module 5, e-PF1 of XaaS module 6 and e-PF2 of XaaS module 6.

In some embodiments, the first MM selects the first involved XaaS module's all ingress PFs and the lastly involved XaaS module's all egress PFs as the one or more selected PFs. For example, the first MM selects the in-PF1 of XaaS module 5, in-PF2 of XaaS module 5, the e-PF1 of XaaS module 6 and e-PF2 of XaaS module 6 as the one or more selected PFs.

Step 804: the first MM sends the PF IDs of the one or more selected PFs to the second MM. There are two options to send the PF IDs to the second MM.

Option 1: the first MM sends the PF IDs of the one or more selected PFs to the second MM directly, the first MM sends a first registration request message to the second MM, which means the first MM registers to the second MM. The first registration request message includes the PF IDs of the one or more selected PFs. In some embodiments, the first registration request message further includes the submission IDs of the submissions supported by the first MM and processing function attribute, the processing function attribute includes at least one of: processing function type (e.g., ingress PF, egress PF) of each of the one or more selected PFs, supported submission IDs and/or task IDs by each of the one or more selected PFs, location (e.g., cell, network, tracking area, geographical area) of each of the one or more selected PFs, capability (e.g., data processing capability, computing capability, and communication capability) of each of the one or more selected PFs, supported input and output data format of each of the one or more selected PFs.

Option 2: the first MM sends the PF IDs of the one or more selected PFs to the second MM through an NRF. In this option, the first MM registers to the NRF, the first MM sends the PF IDs of the one or more selected PFs to the NRF, the PF IDs of the one or more selected PFs can be included in the first registration request message. In some embodiments, the first registration request message further includes the sub-mission IDs and processing function attribute, the processing function attribute includes at least one of: processing function type, supported task IDs, location, capability, supported input and output data format of processing function. In option 2, the method further comprises step 806 and step 807 (in option 1, the step 806 and step 807 can be skipped).

Step 805: A second MM receives a message, e.g., a request message from a UE, an AF, a NF, or the management plane (e.g., OAM), the request message can be a mission data plane establishment request message, and a mission ID is included in the message, the mission ID indicates a mission that the UE, the AF, the NF or the OAM request the network to execute. The NF includes CM, RM, etc. The second MM invokes the Mission graph or the Mission instance information (invokes Mission graph in Mission instantiation phase, and invokes Mission instance information in mission data plane establishment phase) corresponding to the Mission ID from local storage or from Mission data Repository (MDR), the Mission graph or the Mission instance information indicates the submission(s) and/or task(s) involved in the mission, each submission is identified by a submission ID. In some embodiments, the Mission graph or the Mission instance information indicates not only the submission(s) but also task(s) involved in the mission, and each task is identified by a task ID. It means that the task(s) involved in the mission can be provided by a XaaS module directly controlled by the second MM instead of the first MM. In this embodiment, the second MM is the global MM. For example, the second MM receives a mission ID of the mission in FIG. 1, the second MM invokes the mission graph or the mission instance information to obtain the submission ID of the submission 1 and the submission 2, and obtain the task ID of the task 4 and task 7.

Step 806: the second MM sends the submission ID(s) and/or the task ID(s) obtained from the step 805 to the NRF. The submission ID(s) and/or the task ID(s) can be included in a XaaS module discovery request message.

Step 807: the NRF sends a response message, e.g., a XaaS module discovery response message to the second MM, the message includes the submission ID(s) received in Step 806, Domain MM ID(s) identifying the domain MM(s) which support to execute the submission(s) identified by the submission ID(s), the PF IDs of the one or more selected PFs, at the same time, the attributes of PFs are also included. The PF IDs identify the PFs who can provide the submission identified by the submission ID(s), and the Domain MM ID(s) identifies the Domain MM(s) which the PFs are underneath. For example, the first MM can be the domain MM who supports the submission 1, and the other domain MM supports the submission 2, then the domain MM ID of the first MM and the domain MM ID of the other domain MM supporting the submission 2 will be included in the message.

Step 808: the second MM selects one or more boarder PFs from the one or more selected PFs. Based on the attribute of the PFs underneath the first MM, and at least one of: the attribute of GW (e.g., GW load, GW location) underneath the first MM and/or the second MM, the attribute of the PFs underneath the second MM, considering communication (e.g., data forwarding) and computing (e.g., data processing) efficiency, the second MM can select the PFs underneath the first MM, GWs underneath the second MM jointly. For example, the second MM selects the in-PF1 of XaaS module 5 and e-PF2 of XaaS module 6 as the boarder PFs.

Step 809: The first MM receives one or more boarder PF IDs of the one or more boarder PFs from the second MM. In some embodiments, the second MM sends a message e.g., a command message to the first MM, the command message can be a Mission data plane establishment command message. The message includes at least one of: the one or more boarder PF IDs of the one or more boarder PFs, the mission ID, the submission ID, and GW IDs of the selected GWs underneath the second MM to the first MM.

In some embodiments, after receiving the one or more boarder PF IDs, the first MM continue to select the GWs underneath the first MM, and selects the intermediate PFs (e.g., egress PF of the firstly involved XaaS module, ingress PF of the lastly involved XaaS module, and the ingress and egress PFs of the intermediate XaaS modules) of the submission, based on the second MM's selected boarder PFs and/or GWs. For example, the first MM selects the e-PF of XaaS module 5 and the in-PF of XaaS module 6 as the intermediate PFs.

Step 810: The first MM sends the one or more boarder PF IDs of the one or more boarder PFs to the service controller. Optionally, the first MM further sends the intermediate PFs and GWs underneath the first MM to the service controller. For example, the first MM sends the PF IDs of the in-PF1 of XaaS module 5 and e-PF of XaaS module 5 to the XC5, the first MM sends the PF IDs of the in-PF of XaaS module 6 and e-PF2 of XaaS module 6 to the XC6. In some embodiments, the first MM sends a message, e.g., a require message to the service controller, the require message can be a mission data plane establishment require message, the mission data plane establishment require message includes the one or more boarder PF IDs, and the mission data plane establishment require message further includes the one or more sub-mission IDs and the one or more task IDs.

In some embodiments, Each XC configures the PFs selected by the first MM, setups the connection between PFs and GWs.

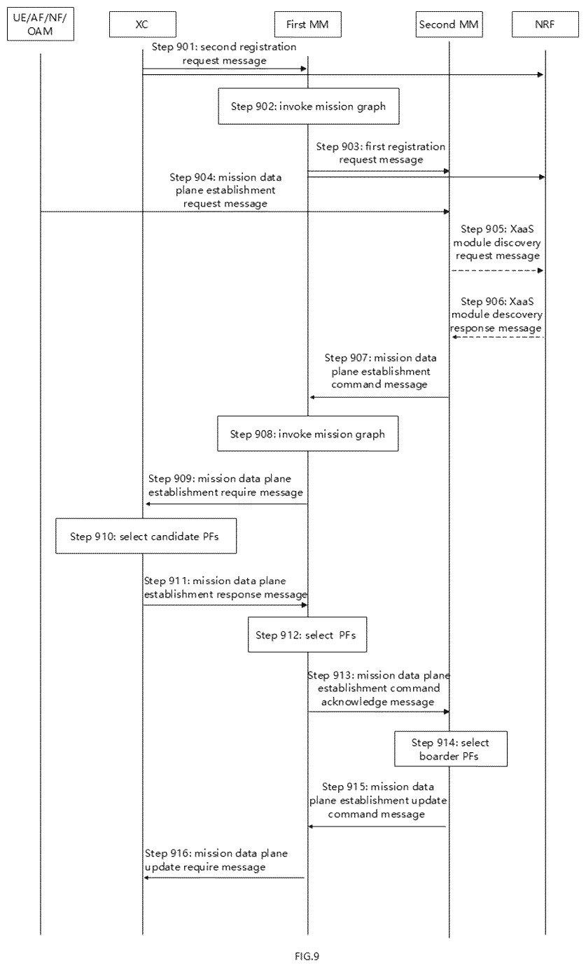

FIG. 9 shows another embodiment of a workflow of a processing function selection method in accordance with the present disclosure. The embodiment of FIG. 9 describes a processing function selection method with hierarchical MM. The processing function selection method comprises:

Step 901: the service controller sends a second registration request message to a first MM or network function (e.g., NRF), the second registration request message includes the supported task IDs, the supported task IDs includes the IDs of the tasks the PFs underneath the service controller are able to execute. Similar to the step 801, the first MM can be the domain MM. When the service controller registers to the first MM directly, the service controller sends the second registration request message to the first MM, the first MM obtains the supported task IDs from the service controller directly. The network function could be an existing 5G network function, e.g., Network repository function (NRF) or other existing network functions, or could be a new defined 6G network function. The following steps are described using an example where the network function is an NRF. When the service controller registers to the NRF, the service controller send the second registration request message to the NRF, the first MM obtains the supported task IDs from the service controller through the NRF. The service controller can be any service controller in FIG. 2, for example, the service controller can be one or more XC of XC1-XC3, then service controller will send the second registration request message to the leftmost domain MM in FIG. 2, the leftmost domain MM is the first MM. The service controller can be XC5 and/or XC6, then the service controller will send the second registration request message to the rightmost domain MM in FIG. 2, the rightmost domain MM is the first MM.

Step 902: the first MM invokes submission graph or submission information. The details of this step can be referred to the step 802. In this step, the first MM can obtain the submission IDs and the task IDs through invoking the submission graph, the submission IDs identify the submissions supported by the first MM, the task IDs identify the tasks involved in the submissions. For example, the first MM is the leftmost MM in FIG. 2, referring to FIG. 1, the first MM supports the submission 1, the submission ID indicates the submission 1, the task IDs indicates the task 1, task 2 and task 3.

Step 903: the first MM sends a message, e.g. a first registration request message to a second MM or the NRF. When the first MM registers to the second MM, the first MM sends the first registration request message to the second MM, when the first MM registers to the NRF, the first MM sends the first registration request message to the NRF, the first registration message includes the submission IDs obtained in step 902.

Step 904: A second MM receives a message, e.g., a request message from a UE, an AF, a NF, or the management plane (e.g., OAM), the request message can be a mission data plane establishment request message, and a mission ID is included in the message, the mission ID indicates a mission that the UE, the AF, the NF or the OAM request the network to execute. The details of this step can be referred to the step 805. When the first MM registers to the NRF, the method further comprises the steps 905 and 906, otherwise, the steps 905 and 906 can be skipped.

Step 905: the second MM sends the submission ID(s) and/or the task ID(s) obtained from the step 904 to the NRF. The submission ID(s) and/or the task ID(s) can be included in a XaaS module discovery request message.

Step 906: the NRF sends a message, e.g., a XaaS module discovery response message to the second MM, the message includes the submission ID(s) received in Step 905, Domain MM ID(s) identifying the domain MM(s) which support to execute the submission(s) identified by the submission ID(s), the details of this step can be referred to the step 807.

After executing the above steps, the second MM obtained the supported submission IDs of the submissions supported by the first MM, further, the second MM can also obtain the supported submission IDs of the submissions supported by the other domain MMs. The second MM also obtained the mission ID of the mission that the UE, the AF, the NF or the OAM request the network to execute, the submission IDs of the submissions involved in the mission through the second MM invoking the mission graph or the mission instance information. Based on the information about the supported submission IDs and the submission IDs of the submissions involved in the mission that the UE, the AF, the NF or the OAM request, the second MM can know which domain MM supports which submissions involved in the mission. For example, the second MM will know the first MM can support the submission 1 involved in the mission.

Step 907: the first MM receives a message, e.g., a command message from the second MM, the command message can be a mission data plane establish command message, the message includes the mission ID and the submission ID, the submission ID identifying the submission the first MM need to execute, in other words, the submission is supported by the first MM and also involved in the mission.

Step 908: the first MM invokes the submission graph or the submission instance information (invokes submission graph in submission instantiation phase, and invokes submission instance information in submission data plane establishment phase) from its local storage or MDR, the submission graph or the submission instance information indicates the tasks involved in the submission identified by the submission ID received in step 907, and each task is identified by a task ID.

Step 909: the first MM sends the submission ID, the task IDs to the service controllers who support one or more tasks identified by the task IDs. The submission ID and the task IDs are included in a message, e.g., a require message, the require message can be a mission data establishment require message. The mission data plane establishment require message is for selecting the candidate processing functions by the service controller. For example, the first MM sends the ID of the submission 1 and the ID of task 1 to the XC1, the first MM sends the ID of the submission 1 and the ID of task 2 to the XC2, the first MM sends the ID of the submission 1 and the ID of task 3 to the XC3.

Step 910: the service controller selects the candidate PFs from the PFs the service controller connected to. As an example, the service controller selects the candidate PFs based on the submission ID, the task IDs received from the first MM and the attribute of the PFs the service controller connected to. For example, the service controller is the XC1, the submission ID received in step 909 indicates the submission 1, and the task ID received in step 909 indicates the task 1, the XC1 determines the in-PF1, inPF2 and e-PF can support the task 1, then the XC1 will select the in-PF1, inPF2 and e-PF as the candidate PFs.

Step 911: the first MM receives the IDs of the candidate PFs from the service controller. The IDs of the candidate PFs can be included in a message, e.g., a response message, the response message can be a mission data plane establishment response message. In some embodiments, the response message further includes at lease one of: the submission ID, the task ID and the attributes of the candidate PFs. The submission ID identifies the submission the service controller need to execute, for example, when the service controller is the XC1, the submission ID is the ID of the submission 1. The task ID identifies the task involved in the submission 1, for example the task ID of the task 1. the attributes of the candidate PFs comprises at least one of: processing function type (e.g., ingress PF, egress PF) of each of the candidate PFs, the supported task IDs of each of the candidate PFs, location (e.g., cell, network, tracking area, geographical area) of each of the candidate PFs, capability (e.g., data processing capability, computing capability, and communication capability) of each of the candidate PFs, supported input and output data format of each of the candidate PFs.

Step 912: the first MM selects one or more selected PFs from the received candidate PFs. In some embodiments, the first MM selects the one or more selected PFs and the GWs jointly based on the attribute of the candidate PFs and the attribute of the GWs. In some embodiments, when the first MM receives the PF IDs of the candidate PFs from the service controllers controlled by the first MM (for example, the XC1, the XC2 and the XC3), the first MM arranges the PFs in sequence based on the sequence of the tasks involved in the submission the MM supported, and selects one or more selected PFs based on the sequence of the PFs. Specifically, the sequence of the tasks involved in the submission can be understood as the processing sequence of the tasks. For example, when executing the submission 1, the sequence of the task will be task 1, task 2 and task 3. In some embodiments, when arranging the PFs in sequence, all the in-PFs can be sorted together, and all the e-PFs can be sorted together. Based on the sequence of the task 1, task 2 and task 3, the order of the in-PFs will be in-PF1 of XaaS module 1, in-PF2 of XaaS module 1, in-PF1 of XaaS module 2, in-PF2 of XaaS module 2, in-PF of XaaS module 3 and i/e-PF of XaaS module 3, the order of the e-PFs will be e-PF of XaaS module 1, e-PF of XaaS module 2, i/e-PF of XaaS module 3 and e-PF of XaaS module 3.

In some embodiments, the first MM selects the first involved XaaS module's all ingress PFs and the lastly involved XaaS module's all egress PFs as the one or more selected PFs. For example, the first MM selects the in-PF1 of XaaS module 1, in-PF2 of XaaS module 1, the i/e-PF of XaaS module 3 and e-PF of XaaS module 3 as the one or more selected PFs.

Step 913: The first MM sends the PF IDs of the one or more selected PFs to the second MM. The PF IDs of the one or more selected PFs are included in a message, e.g., a mission data plane establishment command acknowledge message. The message may also include the attribute of the one or more selected PFs.

Step 914: the second MM selects one or more boarder PFs from the one or more selected PFs. Based on the attribute of the PFs underneath the first MM, and at least one of: the attribute of GW (e.g., GW load, GW location) underneath the first MM and/or the second MM, the attribute of the PFs underneath the second MM, considering communication (e.g., data forwarding) and computing (e.g., data processing) efficiency, the second MM can select the PFs underneath the first MM, GWs underneath the second MM jointly. For example, the second MM selects the in-PF2 of XaaS module 1 and i/e-PF of XaaS module 3 as the boarder PFs.

Step 915: the first MM receives PF IDs of the one or more boarder PFs from the second MM. In some embodiments, the second MM sends a message, e.g., a Mission data plane update command message to the first MM. The message includes the one or more boarder PF IDs of the one or more boarder PFs, the mission ID, the message may further includes at least one of: the mission ID, the submission ID, and GW IDs of the selected GWs underneath the second MM to the first MM, the submission ID identifies the submission the first MM executes (for example, the submission ID of the submission 1). In some embodiments, after receiving the one or more boarder PF IDs, the first MM continue to select the GWs underneath the first MM, and selects the intermediate PFs (e.g., egress PF of the firstly involved XaaS module, ingress PF of the lastly involved XaaS module, and the ingress and egress PFs of the intermediate XaaS modules) of the submission, based on the second MM's selected boarder PFs and/or GWs. For example, the first MM selects the e-PF of XaaS module 1, the in-PF1 of XaaS module 2 and the e-PF of XaaS module 2 as the intermediate PFs.

Step 916: The first MM sends the one or more boarder PF IDs of the one or more boarder PFs to the service controller. Optionally, the first MM further sends the intermediate PFs and GWs underneath the first MM to the service controller. In some embodiments, the first MM sends a mission data plane update require message to the service controller, the mission data plane update require message includes the one or more boarder PF IDs, and the mission data plane update require message further includes the submission ID and the task IDs. The submission ID indicates the submission executed by the first MM, the task IDs indicates the tasks executed by the controller. For example, the submission ID indicates the submission 1, the task ID indicates the task 1 when the service controller is XC1.

In some embodiments, Each XC configures the PFs selected by the first MM, setups the connection between PFs and GWs.

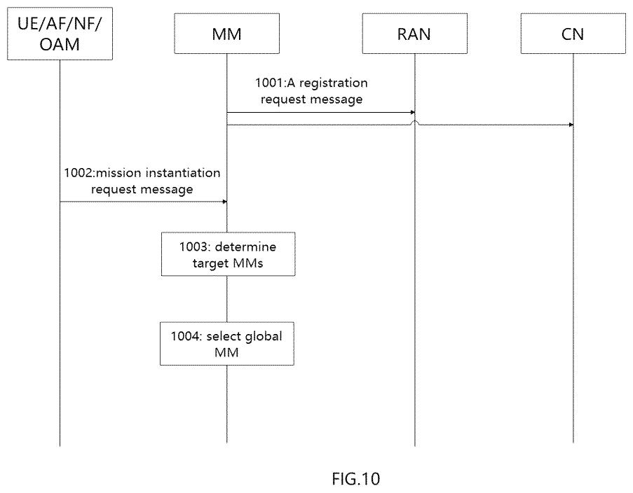

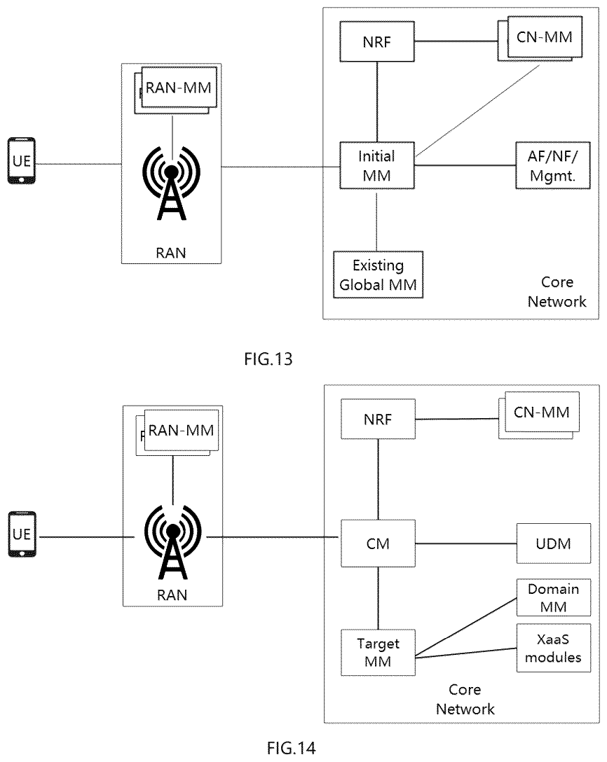

FIG. 10 shows another embodiment of a workflow of a selection method for mission instantiation in accordance with the present disclosure. FIG. 13 shows the corresponding one possible system architecture. In some embodiments, the resources used to execute a type of mission must be instantiated in order to execute the mission later, and the result of the mission instantiation is the mission instance. Mission instance is the resource pool parts or all of which can be selected to execute the mission later. The resource could be computing resource, communication resource, etc. And the resource can be provided by specific network infrastructure, e.g., RAN, core network function, device, etc. A mission instance could consist of one or multiple submission instances and/or task instances. For example, the mission instantiation procedure could be done in the network deployment and management phase, and the mission execution procedure can be done in network operation phase, e.g., in the phase of providing services to a customer by the network. In some optional application scenario, this embodiment can be combined with the former embodiments. The former embodiments describe a method of selecting processing functions, and it assumes that the global MM is already selected, and the UE/NF/AF sends request to global MM who controls the PF select procedures. This embodiment describes a method of selecting mission management function for mission instantiation. In this method, a global MM of a mission is selected among multiple MMs under the control of an initial MM. The method comprising:

Step 1001: Each of one or more MMs send a registration request message, the registration request message indicates one or more missions supported by the each of the one or more MMs or one or more submissions supported by the each of the one or more MMs. In some embodiments, the MM can be a RAN-MM or CN-MM. When the MM is a RAN-MM, the RAN-MM sends the registration request message to a RAN function (e.g., a RAN node), the RAN-MM is deployed in the RAN. When the MM is a CN-MM, the MM sends the registration message to a CN function (e.g., an NRF), the CN-MM is deployed in the CN. The one or more MMs comprise an initial MM randomly selected by the network to serve a UE when the UE performs an initial access to the network. The initial MM can also be referred as a first MM. The RAN function is deployed in RAN. The RAN function could be an existing 5G RAN function, e.g., a RAN node or other existing RAN functions, or could be a new defined 6G RAN function. The CN function can be deployed in CN. The CN function could be an existing 5G CN function, e.g., Network repository function (NRF) or other existing network functions, or could be a new defined 6G CN function. The following steps are described using an example where the CN function is an NRF.

In some embodiments, the registration request message includes one or more supported mission IDs and/or one or more supported submission IDs, the one or more supported mission IDs indicate the one or more missions supported by the MM, the one or more supported submission IDs indicate the one or more submissions supported by the MM. The registration request message may further include at least one of: mission context and submission context. The mission context is for describing the mission supported by the MM. As an example, the mission context can be some information including at least one of: the mission identified by the mission ID is only supported in specific area (e.g., specific cell, tracking area, location), the mission identified by the mission ID is only supported in specific network identified by Public Land Mobile Network (PLMN) ID or Non-Public Network (NPN) ID, the mission identified by the mission ID is only supported in specific time, or under specific condition. Moreover, the mission context may indicate the involvement of the RAN and CN to execute the mission identified by the mission ID, e.g., both the RAN and CN should be involved when there are submission instances and/or task instance in both RAN and CN, and only RAN or only CN should be involved when there are submission instances and task instance only in RAN or only in CN. For example, it indicates that RAN should be involved when the instance on RAN side is involved in the whole mission instance. The submission context can be some information including at least one of: the submission identified by the mission ID is only supported in specific area (e.g., specific cell, tracking area, location), the submission identified by the submission ID is only supported in specific network identified by Public Land Mobile Network (PLMN) ID or Non-Public Network (NPN) ID, the submission identified by the submission ID is only supported in specific time, or under specific condition.

Step 1002: The initial MM receive a message, e.g., a first request message from a UE, an AF, a network function (NF), or management plane (e.g., OAM), the first message can be a mission instantiation request message. The NF includes CM, RM, etc. The message indicates a requested mission, in some embodiments, the message includes a mission ID, the mission ID identified a mission that the UE or AF requests to be executed. The message may further include a mission context, the mission context is used to describe the mission identified by the mission ID. The mission context comprises parts of or all the information below: information indicates the involvement of the RAN and CN to execute the mission identified by the mission ID, e.g., both the RAN and CN should be involved when there are submission instances and/or task instance in both RAN and CN, and only RAN or only CN should be involved when there are submission instances and task instance only in RAN or only in CN. For example, it indicates that RAN should be involved when the instance on RAN side is involved in the whole mission instance. information indicates whether the mission instance should be available in specific area (e.g., specific cell, tracking area, location), in specific network identified by PLMN ID or NPN ID, in specific time, under specific condition).

Step 1003: The initial MM determines one or more target MMs, the one or more target MMs are capable of providing the requested mission or one or more submissions involved in the requested mission. Specifically, the initial MM invokes mission graph and mission instance information, the mission graph indicates the composition of a mission, for example the composition of a mission indicates one or more tasks or submissions involved in the mission, and the sequence of these tasks and/or submissions. The mission instance information indicates the resource used for executing these tasks and/or submissions, the resource includes network entity who can execute the tasks and/or submissions. The resource could be data forwarding resource, computing resource, communication resource, data storage resource, etc. And the resource can be provided by specific network infrastructure, e.g., RAN, core network function, device, etc. The initial MM will obtain task IDs identifying the tasks and/or submission IDs identifying the submissions involved in the mission requested by the UE, AF, NF or OAM, the initial MM checks whether there are already one or more required mission instances exist in network based on the task IDs/submission IDs and the mission instance information. The required mission instance is the mission instance used to executing the tasks and/or submissions involved in the mission. If the initial MM determines there is already at least one required mission instance in network, then the MM who controls or coordinates the required mission instance will be regarded as the target MM, in this situation, the target MM will be the global MM. If the initial MM determines there is no required mission instance in the network, then the one or more steps of step 1003-a to 1003-f will be performed.

Step 1003-a: the initial MM sends a discovery message to the CN function (e.g., NRF) or the RAN function (e.g., RAN node). When the initial MM is RAN-MM, the initial MM sends the discovery message to the RAN function, when the initial MM is CN-MM, the initial MM sends the discovery message to the CN function (e.g., NRF). The discovery message includes the mission ID identifying the mission requested by the UE, AF, NF or OAM. The discovery message may further include mission context, the mission context is for describing the mission, the submission ID identifying the submission involved in the mission, the submission context.

Step 1003-b: The CN function (e.g., NRF) or the RAN function checks whether a required mission instance controlled by an existing MM already exists in the network (e.g., both in RAN and CN) based on the information included in the discovery message. If there's a required mission instance in the network, the existing MM controlling the required mission instance will be regard as the target MM, in this situation, the target MM will be the global MM. The CN function (e.g., NRF) or the RAN function will send the ID of the global MM to the initial MM. The initial MM can contact the global MM based on the global MM ID, and forward the information included in the message received from the UE, AF, NF or OAM in step 1002 to the global MM, the global MM responds to the UE, AF, NF or OAM, and the procedure will be end. If there's no required mission instance in the network, the CN function (e.g., NRF) or the RAN function will find which candidate MMs can provide the submission identified by the submission ID to be involved in the mission, the NRF or the RAN function (e.g., RAN node) will send the ID of the candidate MMs to the initial MM, and the step 1003-c will be further performed.

Step 1003-c: The initial MM send a message, e.g., a second request message to each of the candidate MMs, the second request message can be a submission instantiation request message, the message includes the mission ID obtained from the UE, AF, NF or OAM, and the message further includes the submission ID of the submission involved in the mission.

Step 1003-d: If the submission has not been instantiated, or the instantiated submission has been released (e.g., the submission instance has been removed or deleted), the candidate MM performs the submission instantiation (during which, the candidate MM may interact with its controlled XaaS module (e.g., interacts with XC of the XaaS module) to instantiate the task), then sends a response message to the initial MM, the response message can be a submission instantiation response message. The message includes the mission ID and submission ID. The resources to execute a type of submission must be instantiated in order to execute the submission later, and the result of the submission instantiation is the submission instance. Submission instance is the resource pool parts or all of which can be selected to execute the submission later. The resource could be computing resource, communication resource, etc. And the resource can be provided by specific network infrastructure, e.g., RAN, core network function, device, etc. A submission instance could consist of one or multiple task instances. The candidate MM performs the submission instantiation can also be understood as the candidate MM finds, collects, coordinates and/or configures the resource used for executing the submission in order to execute the submission. If the submission has been instantiated, and the instantiated submission is still available, the candidate MM directly sends the response message to the initial MM.

Step 1003-e: The initial MM determines the one or more target MM from the one or more candidate MM based on the submission instantiation response message. For example, if multiple candidate MMs response that they successfully instantiate a submission identified by a submission ID, only one or some of them can be selected as the target MMs in case redundant resource are instantiated, and the other candidate MMs can release the instantiated resources.

Step 1004: The initial MM selects a second MM from the initial MM and the one or more target MMs. The second MM can be a global MM. The initial MM and the target MM negotiate to selects one of them as the Global MM based on a selection principle, the other MMs can be the domain MM. Then the global MM sends registration update request message to the RAN function or the CN function (e.g., NRF). If the global MM is deployed in the RAN side, the global MM will send the registration update request message to the RAN function, if the global MM is deployed in the CN side, the global MM will send the registration update request message to the CN function (e.g., NRF). The message includes the mission instance configuration information. The mission instance configuration information can be also termed as mission slice configuration information, or mission configuration information. The RAN function and the CN function stores the mission instance configuration information, e.g., into local storage. It should be noted that in the above steps, when a required mission instance is found in the network, then the MM who controls the required mission instance is the global MM. After selecting the global MM, the initial MM contacts the global MM, and forwards the information included in the message received from the UE, AF, NF or OAM in step 1002 to the global MM, the global MM responds to the UE, AF, NF or OAM, and the procedure will be end.

The mission instance configuration information includes at least one of:
global MM ID identifying the global MM, mission ID identifying the mission, submission ID(s) identifying the submission(s) involved in the mission, domain MM ID(s) identifying the domain MM(s) who controls the submission(s), task ID(s) identifying the task(s) involved in the mission, XC ID(s) identifying the XC(s) who controls the task(s), mission slice ID identifying the mission slice, mission instance ID identifying the mission instance, mission context. The mission context may be the update of the mission context in Step 1001.

For the selection principle of the global MM, the selection can depend on the coverage area of a MM (e.g., select a MM located in CN as a global MM instead a MM located in RAN), the number of controlled submissions or tasks by a MM (e.g., select a MM who controls the maximum number of submissions or tasks as the global MM), the communication efficiency (e.g., select a MM who can contact with the other MMs involved in a mission with the lowest communication cost as the global MM).

Each global MM may also store the mission instance configuration information, e.g., into local storage.

There is also submission instance configuration information, e.g., stored in each domain MM's local storage, or in the storage of the CN function/RAN function (e.g., RAN node). The submission instance configuration information can be also termed as submission slice configuration information, or submission configuration information.

The submission instance configuration information includes at least one of:
submission ID identifying the submission, Domain MM ID identifying the Domain MM who controls the submission, task ID(s) identifying the task(s) involved in the mission, XC ID(s) identifying the XC(s) who controls the task(s), submission slice ID identifying the submission slice, submission instance ID identifying the submission instance, submission context.

There is also Task Instance Configuration Information, e.g., stored in each XC's local storage, or in the storage of the CN function/RAN function (e.g., RAN node). The task instance configuration information can be also termed as task slice configuration information, or task configuration information.

The task Instance Configuration Information includes at least one of: task ID identifying the task, XC ID identifying the XC who controls the task, PF ID(s) identifying the PF(s) who has the ability to execute the task, task slice ID identifying the task slice, task instance ID identifying the task instance, task context.

It should be noted that before step 1001, each task may have been already instantiated by corresponding XaaS modules. One or more task instances constitute a submission instance or a mission instance. And each submission may have been also instantiated. The global MM of a mission instance or a mission slice can be unique logically, but the implementation of the global MM can be multiple duplicated physical MM entities. A submission instance could consist of one or multiple task instances. The resources to execute a type of task must be instantiated in order to execute the task later, and the result of the task instantiation is the task instance. Task instance is the resource pool parts or all of which can be selected to execute the task later. The resource could be computing resource, communication resource, etc. And the resource can be provided by specific network infrastructure, e.g., RAN, core network function, device, etc.

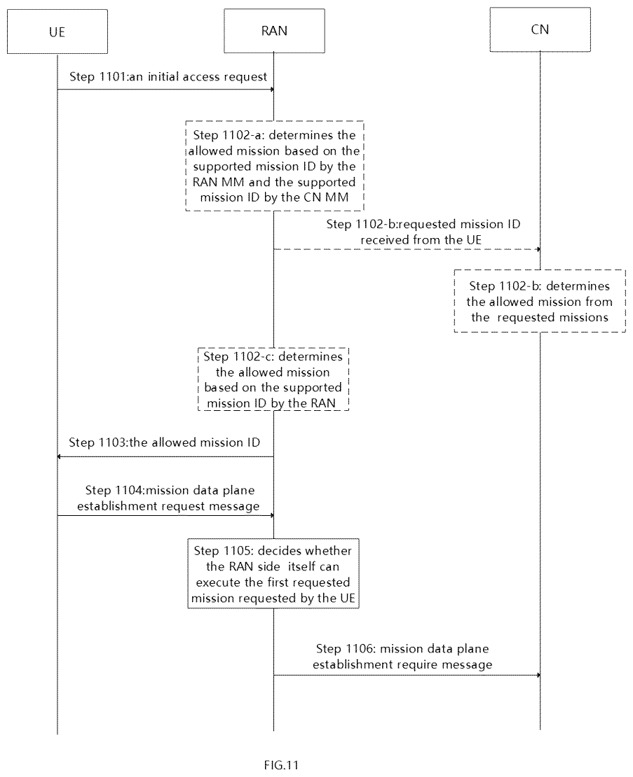

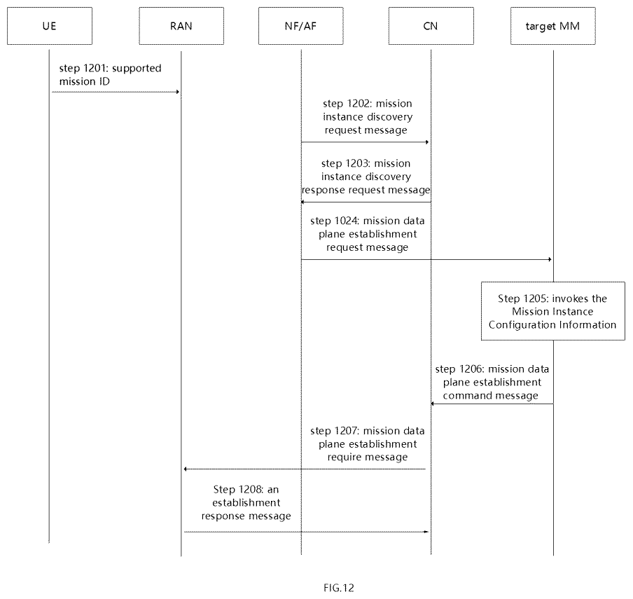

FIG. 11 shows an embodiment of a workflow of an initial access method in accordance with the present disclosure. FIG. 14 shows the corresponding one possible system architecture. In the above embodiments, the methods of selecting the PFs and the global MM have been introduced, after the selection, the UE will initially access the network (e.g., registers to the network) to discover and obtain the allowed mission resource (e.g., mission instance) provided by the network to the UE.

As in FIG. 11, steps for the workflow of the initial access method comprises:

Step 1101: The UE sends an access request message (e.g., an initial access request) to a RAN, the RAN receives the access message (e.g., an initial access request message), the access request message includes at least one requested mission ID, the requested mission ID indicates at least one requested mission.

Before the step 1101, the UE locally stores configured mission ID and mission context, the configured mission ID identified the mission that the UE can request to be executed by the network device (RAN and/or CN), the mission context is used to describe the mission.

The RAN locally stores supported mission ID and mission context, the supported mission ID identified the mission supported by the RAN MM, the mission context is used to describe the mission, this information can be notified by the RAN MM to the RAN. The RAN MM is the MM deployed in RAN.

A network function (e.g., NRF) locally stores supported mission ID and mission context, the supported mission ID identified the mission supported by the CN MM, this information can be notified by the CN MM to the network function. The network function could be an existing 5G network function, e.g., Network repository function (NRF) or other existing network functions, or could be a new defined 6G CN function. The CN MM is the MM deployed in CN. CN MM is the MM deployed in core network (CN). RAN MM is the MM deployed in radio access network (RAN).

RAN and CN function (e.g., CM) may interact with each other to notify their supported mission ID and mission context. For example, RAN sends interface setup request message to CN, the message includes the mission ID and mission context. The mission ID is supported by RAN-MM. CN sends interface setup response message to RAN, the message includes the Mission ID and mission context. The mission ID is supported by CN-MM. In the mission context, as explained before, it may indicate the mission identified by the mission ID is only supported in specific area (e.g., specific cell, tracking area, location), in specific network identified by PLMN ID or NPN ID, etc. Connectivity Management Function (CM) supports Reachability service and Connection service. Reachability service is to perform acquisition and maintenance of locations of end-points. Connection service is to perform maintenance (establishment and removal) of connections between end-points and the 6G System. CM is deployed in CN or RAN.

RAN may send (via broadcast or unicast message, e.g., system information, RRC message, or XaaS signaling message, a paging message) the supported mission ID of network to UE. For example, RAN may broadcast the supported mission ID (e.g., per cell, or per network, or per tracking area) to UE, e.g., to assist UE to perform cell/network selection. The RAN may send a cell ID, a network ID, or a tracking area ID together with the supported mission ID. After receiving the supported mission ID of network, the UE can select from one or more of the overlapped Mission ID(s) between the Supported Mission ID(s) of network and the UE's configured mission ID(s) as the request Mission ID(s).

It should be noted that in the present application the Mission ID may be replaced by Mission slice ID, Mission slice selection ID, Mission instance ID, Mission instance selection ID, Mission selection assistance ID, mission instance selection assistance ID, Mission slice selection assistance ID, Mission slice selection information, Mission instance selection information, mission selection assistance information, mission instance selection assistance information, Mission slice selection assistance information.

After the step 1101, one step of the step 1102-a, step 1102-b and step 1102-c will be performed.

Step 1102-a, the RAN determines the allowed mission from the at least one requested mission based on the supported mission ID by the RAN MM and the supported mission ID by the CN MM. In this situation, the CN side (e.g., connection manager (CM), or CN-MM) has notified the Supported Mission ID of CN-MM to RAN, RAN selects the overlapped mission ID between the Requested Mission ID and the Supported Mission ID by CN or the supported mission ID by the RAN as the Allowed Mission ID to UE. For example, the requested missions are mission 1, mission 2, and mission 3, the supported missions by the CN is mission 2, mission 4 and mission 6, the supported missions by the RAN is the mission 3, mission 4 and mission 5. Then the RAN determines the overlapped missions between the requested missions and the supported missions by the CN is mission 2, the RAN determines the overlapped missions between the requested missions and the supported missions by the RAN is mission 3, then the RAN will determine the mission 2 and the mission 3 are the allowed missions.

Step 1102-b: the RAN sends the requested mission ID received from the UE to the CN for the CN determining the allowed mission from the at least one requested mission. In this situation, the CN has already had the information about the supported mission ID by the RAN. CN selects the overlapped mission ID between the Requested Mission ID and the Supported Mission ID by CN or the supported mission ID by the RAN as the Allowed Mission ID to UE. Optionally, the CN checks the subscription information of the UE, the subscription includes UE's subscribed mission ID, the CN compares the requested mission ID with the UE's subscribed mission ID, if the requested mission ID does not belong to the subscribed mission ID, this corresponding requested mission will not be selected as the allowed mission. For example, the UE's subscribed missions include mission 3 to mission 10, then the requested mission 1 and mission 2 will not be selected as the allowed mission.

In some embodiments, the RAN sends the requested mission ID through an initial UE message (can also be referred as the initial terminal message), the initial UE message includes the requested mission ID, the initial UE message further includes at least one of: UE context (e.g., a cell ID identifying the cell the UE is located in, a tracking area identity (TAI) identifying the tracking area the UE is located in, a public land mobile network (PLMN) ID or non-public network (NPN) ID identifying the network (supported by RAN and CN) the UE is located in or requesting to access, UE ability on data processing and communication), RAN capability. The RAN capability can be the Supported Mission ID by RAN-MM, the Supported Task ID by RAN-XC, or the Supported Submission ID by the RAN-MM. These supported IDs can be all the supported ID of RAN-MM or RAN-XC, or only parts of the supported IDs of RAN-MM or RAN-XC (which are related to the UE's Requested ID). For example, submission ID which is supported by RAN-MM and the submission identified by the submission ID is to be involved in a mission requested by the UE, at the same time the mission cannot be executed by RAN side alone, Task ID which is supported by RAN-XC and the Task identified by the Task ID is to be involved in a mission requested by the UE, at the same time the mission cannot be executed by RAN side alone.

In some embodiments, the requested mission ID can be received by a first CN function (e.g., CM of the CN), the first CN function then sends a message, e.g., a mission selection request message to a second CN function (e.g., NRF of the CN), the mission selection request message includes the requested mission ID, the mission selection request message may further include at least one of: UE's subscribed Mission ID, Mission context, and UE context. The first CN function is deployed in CN. The second CN function is deployed in CN.

In some embodiments, CN (e.g., the first CN function or the second CN function) performs Mission ID selection to decide the UE's allowed Mission ID based on the following factors:
UE's Requested Mission ID, UE's Subscribed Mission ID (which is stored in a third CN function (e.g., UDM) and retrieved by the first CN function or the second function from the third CN function, and the third CN function is deployed in CN), UE context (e.g., UE location which may be reported by RAN or UE to CN (for example, a cell ID identifying the cell the UE is located in, a tracking area identity (TAI) identifying the tracking area the UE is located in, a PLMN ID or NPN ID identifying the network the UE is located in), UE ability on data processing and communication), CN's supported mission ID (e.g., when the CN has deployed the mission instance corresponding to the mission ID, we consider the CN supports the mission ID), Mission context (e.g., the mission identified by a mission ID is only supported in specific area (e.g., specific cell, tracking area, location), in specific network identified by PLMN ID or NPN ID, in specific time, under specific condition). Moreover, the mission context may indicate whether the RAN and CN should be cooperated to execute the mission identified by the mission ID, i.e., whether there are submission instances and/or task instance in both RAN and CN, only in RAN or only in CN. For example, it indicates whether the instance on RAN side is involved in the whole mission instance. The Mission context of a UE may the subset of the Mission context of a mission (For example, a mission is available in specific Cells or TAs, but it is only available to the UE in parts of the Cells or TAS, e.g., depending on the UE's subscription), the work load (e.g., computing or communication load) of the entity (e.g., PF) involved in the mission instance corresponding to the mission ID, and the RAN capability (e.g., the Supported Mission ID by RAN-MM, the Supported Task ID by RAN-XC, or the Supported Submission ID by the RAN-MM. These supported IDs can be all the supported ID of RAN-MM or RAN-XC, or only parts of the supported IDs of RAN-MM or RAN-XC (which are related to the UE's Requested ID)).

For example, when the UE context and the Mission context are consistent with each other, and the work load of the entity is low, the CN (e.g., CM, NRF) can select the overlapped Mission ID as the UE's Allowed Mission ID.

If the UE context and a Mission context are not consistent with each other, or the work load of the entity is high, the CN (e.g., CM, NRF) will not select the Mission ID as the UE's Allowed Mission ID.

When the RAN notifies that a Mission ID can be the UE's Allowed Mission ID by RAN side, while the Mission ID is not the supported Mission ID by CN-MM, if the mission should be executed when both RAN-MM and CN-MM support the mission ID, the Mission ID should not be selected as the UE's Allowed Mission ID; if the mission can be executed when either RAN-MM or CN-MM supports the mission ID, the Mission ID should be selected as the UE's Allowed Mission ID.

When neither the RAN-MM nor the CN-MM supports the Mission ID, if the RAN-MM/RAN-XC can execute parts of the tasks/submission of a mission, and CN-MM/CN-XC can execute the other parts of the tasks/submission of the mission, the Mission ID can be also selected as the UE's Allowed Mission ID.

In some embodiments, after the second CN function (e.g., NRF) selecting the allowed mission, the second CN function (e.g., NRF) sends the allowed mission ID to the first CN function (e.g., CM), as an example, the second CN function (e.g., NRF) sends a message, e.g., a mission selection response message to the first CN function (e.g., CM). The message includes the allowed mission ID, the message may further include at least one of: the Mission context (the Mission context may be the updated Mission context related to the UE. For example, a mission is available in specific Cells or TAs, but it is only available to the UE in parts of the Cells or TAs), and MM ID identifying the target MM which can provide the requested mission to UE. The first CN function (e.g., CM) can use the MM ID to contact with the target MM in the subsequent procedure. CN can store the UE's Allowed Mission ID into local storage.

After CN decides the allowed mission ID(s), CN sends the allowed mission ID to the RAN. For example, after receiving the allowed mission ID from the second CN function (e.g., NRF), the first CN function (e.g., CM) sends the allowed mission ID(s) to the RAN, the first CN function (e.g., CM) sends a message, e.g., an initial UE context setup request message to the RAN, the message includes the allowed mission ID, the message may further includes at least one of: MM ID identifying the target MM which can provide the requested mission to UE. RAN can use the MM ID to contact with the target MM in the subsequent procedure. RAN can store the UE's Allowed Mission ID into local storage.

Step 1102-c: the RAN determines at least one allowed mission from the at least one requested mission based on the supported mission ID by the RAN. The RAN performs mission selection to decide the UE's allowed mission based on at one or more of the following factors: UE's requested mission, RAN MM's supported mission, RAN MM's supported submission, service controller's supported task. In some embodiments, the RAN compares the mission ID of the RAN MM's supported mission and the at least one requested mission ID to determines whether there's overlap. If the requested mission can be supported by the RAN MM, then the RAN determines there's an overlap, the requested mission which can be supported by the RAN MM is the overlapped mission. When all the requested mission can be supported by the RAN MM, then all the requested missions are allowed mission. When some parts of the requested mission is supported by the RAN MM, other parts of the requested mission can not be supported by the RAN MM, then the RAN may send the requested mission which is not supported by the RAN MM to the CN and/or send the requested mission which is supported by the RAN MM to the CN.

In one alternative implementation, the RAN sends the mission ID of the overlapped mission to the CN. For those allowed mission by the RAN, i.e., the overlapped mission, the CN may further check the UE's subscription information, if the allowed mission by the RAN does not belong to the UE's subscription mission, the CN will change the allowed mission as not allowed. Based on the above procedure, the CN determines the final allowed mission. The CN (e.g., CM) sends the allowed mission ID of the final allowed mission to the RAN, then the step 1103 may be performed.

In an example, the RAN MM supports mission 1, mission 2 and mission 3, the requested mission is mission 1, mission 2, mission 3 and mission 4, then the RAN will determines the mission 1, the mission 2 and the mission 3 as the allowed missions, the RAN sends the mission ID of mission 1, mission 2 and mission 3, the CN may further check the UE's subscription information, whether the allowed mission by the RAN belongs to the UE's subscription mission.

In another alternative implementation, the RAN sends the mission ID of the mission can not supported by the RAN to the CN, the CN will determines whether these missions can be as the allowed mission, the details of how the CN determines the allowed mission can be seen in step 1102-b, the CN (e.g., CM) sends the allowed mission ID of the allowed mission to the RAN, then the step 1103 may be performed. In an example, the RAN MM supports mission 1, mission 2 and mission 3, the requested mission is mission 2, mission 3 and mission 4, the RAN determines the mission 2 and mission 3 as the allowed missions, the RAN sends the mission 4 to the CN for the CN determining whether the mission 4 can be as the allowed mission. The RAN sends the requested mission ID through an initial UE message, the initial UE message includes the requested mission ID which cannot be supported by the RAN. The details of the CN determining the allowed mission can be seen in step 1102-b. The CN function (e.g., CM) sends the allowed mission ID to the RAN, the RAN regards the allowed mission by the RAN and the allowed mission by the CN as the allowed missions, then the step 1103 may be performed.

In another alternative implementation, the RAN MM may send the requested mission which is not supported by the RAN MM and the requested mission which is supported by the RAN MM to the CN, the requested mission which is supported by the RAN can also be understood as the allowed mission by the RAN. The RAN MM may send the requested mission which is not supported by the RAN MM and the requested mission which is supported by the RAN MM in a same message, in this situation, the message includes two lists of the mission ID, one list includes the allowed mission ID, and the other list includes the requested mission ID of the requested mission which is not supported by the RAN. Or the message includes one list of the mission ID, the allowed mission ID and the requested mission ID of the requested mission which is not supported by the RAN can be identified separately. Or the allowed mission ID and the requested mission ID of the requested mission which is not supported by the RAN can be sent to the CN in separate messages. For those requested mission which is not supported by the RAN, the CN will determine whether these mission can be as the allowed mission, the details of how the CN determines the allowed mission can be seen in step 1102-b. For those allowed mission by the RAN, the CN may further check the UE's subscription information, if the allowed mission by the RAN does not belong to the UE's subscription mission, the CN will change the allowed mission as not allowed. Based on the above procedure, the CN determines the final allowed mission. The CN (e.g., CM of the CN) sends the allowed mission ID of the final allowed mission to the RAN, then the step 1103 may be performed.

Step 1103: The RAN sends the allowed mission ID to the UE, the RAN may send a message to the UE, the massage for example is an initial access response (e.g., Registration request, mission selection request) message. The message includes UE's Allowed Mission ID. UE stores the UE's Allowed Mission ID into local storage for the subsequent use (e.g., for the subsequent mission data plane establishment request).

An initial UE access procedure is described in steps 1101-1103, it should be noted that, some steps can be skipped in the embodiment, and we do not limit the sequence of these steps. After the initial UE access procedure, the UE obtain its allowed mission ID, when the UE wants to participate into a mission or to execute a mission, the UE sends the message including suitable Mission ID selected from the Allowed Mission ID(s) to the network. And the network can establish the mission data plane using the existing mission instance corresponding to the request Mission ID to enable the UE's mission execution (i.e., data processing and data forwarding service). With continued reference to FIG. 11, steps 1104-1106 show the workflow of the mission data plane establishment request procedure of UE, the steps 1104-1106 may be separated from FIG. 11 as a separate technical solution.

Step 1104: The RAN receives a message from the UE, the message may be a mission data plane establishment request message, the message is for requesting establishment of mission data plane for an requested mission, the requested mission is one of the missions indicated by the at least one allowed mission ID. To establish the mission data plane, the resources (e.g., data forwarding resource, data processing resource, data computing resource, data storage resource) to execute the mission should be prepared and established by the RAN or the CN. In order to distinguish from the requested mission in the foregoing steps, the requested mission in this step and the subsequent steps may be referred to as a first requested mission. The message may further include at least one of: Mission session ID (or Mission data plane ID). The Mission session ID (or Mission data plane ID) is to identify the mission data plane requested to be established. When selects the first requested mission from the allowed Missions, the mission context and/or the following information may be considered by the UE: mission selection policy (which may be pre-configured to UE by network): UE maps the upper layer Application to the Mission ID based on Mission selection policy, UE reports the Mission ID to network. Or UE maps the Application to the Mission slice ID based on Mission slice selection policy, UE reports the Mission slice ID to network. The Mission selection policy indicates the data belonging to a particular Application should be delivered and processed via a Mission identified by a Mission ID. The Mission slice selection policy indicates the data belonging to a particular Application should be delivered and processed via a Mission slice identified by a Mission slice ID.

Step 1105: The RAN decides whether the RAN side (e.g., the mission instance deployed in RAN) itself can execute the first requested mission requested by the UE. For example, if there is overlap between the UE's Allowed Mission ID(s) stored in RAN and the Mission ID(s) corresponding to the Mission instance(s) deployed in RAN, and the first requested mission ID belongs to the UE's Allowed Mission ID(s) stored in RAN, at the same time, the mission context and the UE context are consistent with each other, RAN consider the RAN side can execute the first requested mission by itself, otherwise, the RAN consider the RAN side can't execute the first requested mission by itself. When the RAN decides the RAN side can't execute the first requested mission by itself, the step 1106 may be performed, otherwise, step 1106 is kipped, and the RAN or RAN-MM or RAN-XC perform the selection of PFs and GWs on RAN side for the mission session (or mission data plane), then connect and configure the selected PFs and GWs for data processing and data forwarding. The RAN or RAN-MM or RAN-XC should decide the tasks or submission(s) to be executed by the UE. At the same time, the RAN-XC controls RAN-PFs to configure XRB(s) for the UE(s). RAN sends Mission data plane establishment response message to the UE. The message may be sent from RAN-XC or RAN MM, and RAN forwards the message to the UE. The message includes one or more of: task ID, XRB ID, the configuration on the XRB, Mission ID, and Submission ID. The message may be sent e.g., via Paging, via System Information (SI), via RRC, XaaS signaling bearer.

Step 1106: the RAN sends a message to a first CN function (e.g., CM), for example, the message is a mission data plane establishment require message. The message includes the Mission ID of the first requested mission (first requested mission ID). The message may further include at least one of: Mission session ID (or Mission data plane ID), and UE context (e.g., a cell ID identifying the cell the UE is located in, a tracking area identity (TAI) identifying the tracking area the UE is located in, a PLMN ID or NPN ID identifying the network the UE is located in, UE ability on data processing and communication). The first CN function is deployed in CN.

If the first CN function (e.g., CM) has locally stored the UE's Allowed mission ID(s) and the Mission Context. The first CN function (e.g., CM) verifies whether the UE's request is allowed, i.e., whether there is overlap between the first requested mission ID and the UE's Allowed Mission ID(s), there is overlap between the UE's Allowed Mission ID(s) stored in CN and the Mission ID(s) corresponding to the Mission instance(s) deployed in CN, at the same time, the UE context is consistent with the mission context. If there is overlap and the contexts are consistent, the UE's request is allowed, otherwise, the first CN function (e.g., CM) rejects the request. The UE's request can be understood as the UE's request on preparing and establishing the network resources (e.g., data forwarding resource, data processing resource, data computing resource, data storage resource) to be used to execute the first requested mission.

If the first CN function (e.g., CM) has not locally stored the UE's Allowed mission ID. The first CN function (e.g., CM) retrieves the UE's Allowed Mission ID and the Mission Context from a second CN function (e.g., UDM). Then the first CN function (e.g., CM) verifies whether the UE's request is allowed. The second CN function is deployed in CN.

After checking that the UE's request is allowed, i.e., the first requested mission ID is allowed, the first CN function (e.g., CM) may retrieve, a target MM ID identifying a target MM who controls the mission instance corresponding to the first requested mission ID, from other function (e.g., NRF). Specifically, the first CN function (e.g., CM) sends mission instance discovery request message to a third CN function (e.g., NRF) which performs Mission instance selection. The third CN function is deployed in CN. The message includes at least one of: the overlapped Mission ID between the UE's Requested Mission ID (i.e., the first requested mission ID) and the UE's Allowed mission ID(s), and Mission context. The third CN function (e.g., NRF) performs Mission instance selection to decide the target MM who controls the mission instance. For example, the third CN function (e.g., NRF) invokes the Mission Instance Configuration Information (e.g., stored in local storage as described in Step 1004) to check the target MM who controls the mission instance. For example, the third CN function (e.g., NRF) maps the Mission ID to the Mission slice ID, then maps the Mission slice to a particular Mission instance. Then the third CN function (e.g., NRF) invokes the Mission Instance Configuration Information to check the target MM who controls the mission instance. Or, the network maps the Mission slice to a particular Mission instance. Then the third CN function (e.g., NRF) invokes the Mission Instance Configuration Information to check the target MM who controls the mission instance. The third CN function (e.g., NRF) sends mission instance discovery response request message to the first CN function (e.g., CM). The message includes the first requested Mission ID, target MM ID identifying the target MM, and the message may further include at least one of: mission context, mission slice ID, mission instance ID. The message is to notify the first CN function (e.g., CM) of the target MM ID identifying the target MM who controls the mission instance corresponding to the first requested mission ID.

After checking the first requested mission ID is allowed, and retrieves the target MM ID identifying the target MM, the first CN function (e.g., CM) sends mission data plane establishment command message to the target MM (i.e., the global MM) to request for preparing and establishing the corresponding resources to execute the mission. The message includes the first requested Mission ID, and may further includes mission context or Mission session ID or both. Target MM invokes the Mission Instance Configuration Information, and contact with domain MM(s) and/or XC(s) to establish the mission data plane (or mission session) for the UE. For example, the global MM, Domain MM(s), (optional) XC(s) perform the selection of PFs and GWs involved in the mission instance, e.g., based on the steps in the previous embodiments, then connect and configure the selected PFs and GWs for data processing and data forwarding.

For example, if the global MM is a CN-MM, it MM invokes Mission Instance Configuration Information, and contact with domain MMs in CN, (optional) CN-XCs, to perform the selection of PFs and GWs involved in the mission instance on CN side, then the CN-MMs and CN-XCs configure the selected PFs and GWs for data processing and data forwarding. During the procedure, each domain MM may invoke the Submission Instance Configuration Information, and each XC may invoke the Task Instance Configuration Information. RAN sends Mission data plane establishment response message to UE. The message may be sent from RAN-XC, and RAN forwards the message to UE. The message includes the mission ID of the first requested mission, a submission ID identifying submission to be provided by the terminal device which is involved in the first requested mission, a task ID identifying task which is involved in the first requested mission and to be provided by the terminal device, a mission session ID identifying the mission data plane, and mission context including an indication on whether the terminal device should be involved in the mission data plane, a radio bearer ID, and configuration parameter on a radio bearer identified by a radio bearer ID. The message may be a broadcast message, a unicast message, a system information, a radio resource control (RRC) message, a paging message, or a dedicated signaling message to the terminal device.

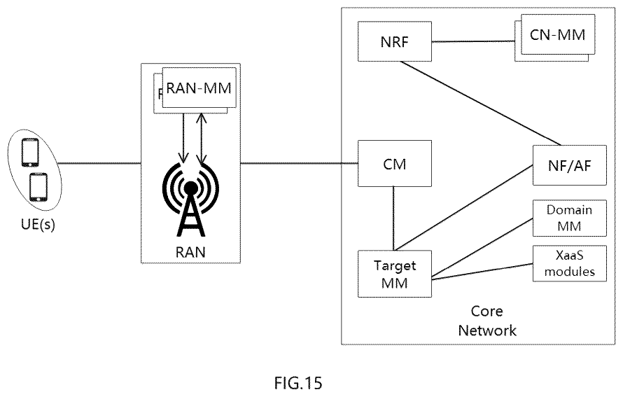

Steps 1104-1106 describes a procedure of UE requesting the mission data plane establishment. In an optional scenario, the mission data plane establishment procedure can be requested by other mission customers, e.g., a network function (NF) deployed in CN or RAN, an application function (AF), or an application server (AS). Please refer to the step 1201-1207 as an alternative of the steps 1104-1106, FIG. 15 shows the corresponding one possible system architecture.

Step 1201: UE reports its supported mission ID to the RAN in a report message. The UE's supported mission ID identifies the mission that the UE is able to execute or participate in, i.e., the UE is capable to provide the resources used to execute the mission. It enables the UE to provide mission service to other mission consumers (e.g., NF, other UE, AF, AS). The allowed mission ID identifies the mission that the UE has the permission to request to the network to execute, and the UE receives mission service corresponding the allowed mission ID from the network. Optionally, the UE may further report at least one of: a submission ID identifying a submission which is supported to be executed by the terminal device, a task ID identifying a task which is supported to be executed by the terminal device, and UE's computing and communication ability on executing the mission. RAN locally stores them. RAN also locally stores the RAN-MM's supported mission ID and mission context. The RAN-MM's Supported Mission ID and mission context may be notified by RAN-MM to RAN. A first CN function (e.g., NRF) locally stores CN-MM's Supported Mission ID and mission context. The CN-MM's Supported Mission ID and mission context may be notified by CN-MM to the first CN function (e.g., NRF). The report message may be one or more of: a broadcast message, a unicast message, a radio resource control (RRC) message, and a dedicated signaling message.

Step 1202: NF/AF sends a message, e.g., a mission instance discovery request message to the first CN function (e.g., NRF) which performs Mission instance selection. The message includes a Mission ID and (optional) Mission context. The mission ID indicates the mission that the NF/AF request the network to perform. The CN function (e.g., NRF) performs Mission instance selection to decide the target MM who controls the mission instance. For example, the first CN function (e.g., NRF) invokes the Mission Instance Configuration Information (e.g., stored in local storage as described in Step 1004) to check the target MM who controls the mission instance. The network function could be an existing 5G network function, e.g., Network repository function (NRF) or other existing network functions, or could be a new defined 6G network function. The following steps are described using an example where the network function is an NRF. For example,

The first CN function (e.g., NRF) maps the Mission ID to the Mission slice ID, then maps the Mission slice to a particular Mission instance. Then the CN function (e.g., NRF) invokes the Mission Instance Configuration Information to check the target MM who controls the mission instance. Or, the network maps the Mission slice to a particular Mission instance. Then the first CN function (e.g., NRF) invokes the Mission Instance Configuration Information to check the target MM who controls the mission instance.

Step 1203: the first CN function (e.g., NRF) sends a message, e.g., a mission instance discovery response request message to NF/AF. The message includes the Mission ID, target MM ID identifying the target MM, (optional) mission context, (optional) mission slice ID, (optional) mission instance ID.

Step 1204: NF/AF sends a message, e.g., a mission data plane establishment request message to the target MM (i.e., the global MM). The message includes the Mission ID, (optional) mission context, (optional) Mission session ID. In some embodiment, the message may be sent by the first CN function (e.g., NRF) to the target MM.

Step 1205: Target MM invokes the Mission Instance Configuration Information, and contact with domain MM(s), (optional) XC(s) to establish the mission data plane for the NF/AF. For example, the global MM, Domain MM(s), (optional) XC(s) perform the selection of PFs and GWs involved in the mission instance, e.g., based on the steps in the previous embodiments, then connect and configure the selected PFs and GWs for data processing and data forwarding. For example, if the global MM is a CN-MM, it MM invokes Mission Instance Configuration Information, and contact with domain MMs in CN, (optional) CN-XCs, to perform the selection of PFs and GWs involved in the mission instance on CN side, e.g., based on the steps in the previous embodiments, then the CN-MMs and CN-XCs configure the selected PFs and GWs for data processing and data forwarding. During the procedure, each domain MM may invoke the Submission Instance Configuration Information, and each XC may invoke the Task Instance Configuration Information.

Step 1206: Target MM sends a message, e.g., a mission data plane establishment command message to a second CN function (e.g., CM). The message includes the Mission ID, Submission ID identifying the submission to be provided by the RAN side, (optional) Mission session ID, and (optional) Mission context including the indication on whether RAN side should be involved in the Mission data plane, and/or the indication on whether one or more UEs should be involved in the Mission data plane. The message may further include IDs of the one or more UEs.

Step 1207: the second CN function (e.g., CM) sends mission data plane establishment require message to RAN. The message includes the Mission ID, Submission ID identifying the submission to be provided by the RAN side, (optional) Mission session ID, and (optional) Mission context including the indication on whether RAN side should be involved in the Mission data plane, and/or the indication on whether one or more UEs should be involved in the Mission data plane. RAN invokes Submission Instance Configuration Information of the RAN side, and contacts with domain RAN-MMs, (optional) XCs, and forwards the mission data plane establishment response message to RAN-MM and (optional) XCs. RAN-MM contacts with the global MM in CN (directly or via intermediate entities e.g., RAN and CM) and RAN-XCs, to perform the selection of PFs and GWs involved in the mission instance on RAN side, e.g., based on the steps in the previous embodiments, then the RAN-MMs and RAN-XCs configure the selected PFs and GWs for data processing and data forwarding. During the procedure, each RAN-MM may invoke the Submission Instance Configuration Information, and each RAN-XC may invoke the Task Instance Configuration Information. Based on the Mission context, the RAN or RAN-MM or RAN-XC can decide whether UE(s) should be involved in the mission, when the RAN decide UE(s) are to be involved in a mission, the RAN selects one or more UEs. In the process of the RAN selecting the one or more UEs, the RAN or RAN-MM or RAN-XC should decide the tasks to be executed by UE(s), and selects the one or more UEs who have reported the supported task ID, and (optional) Mission ID or Submission ID in Step 1201. At the same time, the RAN-XC controls RAN-PFs to configure XRB(s) for the one or more UEs. The RAN requests the one or more UEs to establish the mission data plane, e.g., the RAN sends Mission data plane establishment demand message to the one or more UEs. The message may be sent from RAN-XC or RAN MM, and RAN forwards the message to the one or more UEs. The message includes one or more of: mission ID of the first requested mission, a submission ID identifying submission to be provided by the terminal device which is involved in the first requested mission, a task ID identifying task which is involved in the first requested mission and to be provided by the terminal device, a mission session ID identifying the mission data plane, and mission context including an indication on whether the terminal device should be involved in the mission data plane, a radio bearer ID, and configuration parameter on a radio bearer identified by a radio bearer ID. RAN may send the message to the one or more UEs, via a broadcast message or a unicast message, e.g., via a Paging message, via a System Information (SI), via a RRC message, or via a dedicated signaling message. The task IDs, XRB IDs, the configurations on the XRBs, and (optional) Mission IDs or Submission IDs sent to different UEs may be different.

Step 1208: The RAN sends an establishment response message for the successful establishment of mission data plane to the CN.

It should be noted that one or more steps in each embodiment can be skipped in some modified embodiments, and one or more steps in each embodiment can be separated from the embodiment to be an independent technical solution. The sequence of the steps in each embodiment can be changed in some modified embodiments in reasonable manner.

Through the descriptions of the preceding embodiments, the present disclosure may be implemented by using hardware only or by using software and a necessary universal hardware platform. Based on such understandings, the technical solution of the present disclosure may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present disclosure. For example, such an execution may correspond to a simulation of the logical operations as described herein. The software product may additionally or alternatively include number of instructions that enable a computer device to execute operations for configuring or programming a digital logic apparatus in accordance with embodiments of the present disclosure. Persons of ordinary skill in the art may understand that all or some of the steps of the method embodiments may be implemented by one or more chip products.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

In various embodiments, the management and control modules include a mission management module configured to interoperate with one or more of the service modules to perform a specified mission, said mission comprising a specified set of tasks or operations. The mission management module may interoperate with two or more of the service modules to perform the specified mission, and the mission management module may cause one or more interconnections to be established between said two or more of the service modules in support of the specified mission. One or more terminals, application servers, or both, may be operatively coupled to one or more of the service modules and operate to support the specified mission. Finally, it should be noted that the foregoing embodiments are merely intended for describing the technical solutions of this application other than limiting this application. Although this application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of this application.

What is claimed is:

1. An initial access method, comprising:
receiving, by a radio access network (RAN), an access request message from a terminal device, wherein the access request message includes at least one requested mission identifier (ID), the at least one requested mission ID indicating at least one requested mission;
determining, by the RAN, at least one allowed mission from the at least one requested mission; and
sending, by the RAN, a mission ID of the at least one allowed mission to the terminal device.

2. The method according to claim 1, wherein determining, by the RAN, the at least one allowed mission from the at least one requested mission comprises determining, by the RAN, an allowed mission ID from the at least one requested mission ID.

3. The method according to claim 2, wherein determining, by the RAN, the allowed mission ID from the at least one requested mission ID comprises:
determining, by the RAN, whether there's an overlap between at least one supported mission ID and the at least one requested mission ID, wherein the at least one supported mission ID indicates at least one mission supported by at least one mission management function of the RAN or a core network (CN); and
selecting, by the RAN, an overlapped mission ID as the allowed mission ID.

4. The method according to claim 3, wherein determining, by the RAN, the allowed mission ID from the at least one requested mission ID comprises:
sending, by the RAN, an initial terminal message to a core network (CN), the initial terminal message including the at least one requested mission ID; and
receiving, by the RAN, one or more allowed mission IDs of the at least one allowed mission from the CN.

5. The method according to claim 3, wherein determining, by the RAN, the allowed mission ID from the at least one requested mission ID comprises:
at least one of:
determining, by the RAN, one or more of the at least one requested mission ID does not overlap with any supported mission ID, the supported mission ID indicating at least one mission supported by at least one mission management function of the RAN; or
determining, by the RAN, one or more of the at least one requested mission ID is not supported by the RAN in a cell, a tracking area, or a network the terminal device requests to access;
sending, by the RAN, an initial terminal message to a core network (CN), the initial terminal message including the one or more of the at least one requested mission ID; and
receiving, by the RAN, one or more allowed mission IDs of the at least one allowed mission from the CN.

6. The method according to claim 3, wherein determining, by the RAN, the allowed mission ID from the at least one requested mission ID comprises:
determining, by the RAN, at least one overlapped mission ID between the at least one requested mission ID and the at least one supported mission ID, the at least one supported mission ID indicating at least one mission supported by at least one mission management function of the RAN;
sending, by the RAN, an initial terminal message to the CN, the initial terminal message including the at least one overlapped mission ID; and
receiving, by the RAN, one or more allowed mission IDs of the at least one allowed mission from the CN.

7. The method according to claim 6, wherein determining, by the RAN, the at least one overlapped mission ID further comprises:
determining, by the RAN, the at least one overlapped mission ID is supported by the RAN in a cell, a tracking area, or a network the terminal device requests to access.

8. The method according to claim 3, wherein determining, by the RAN, the allowed mission ID from the at least one requested mission ID comprises:
determining, by the RAN, at least one overlapped mission ID between the at least one requested mission ID and the at least one supported mission ID, the at least one supported mission ID indicates at least one mission supported by at least one mission management function of the RAN;
at least one of:
determining, by the RAN, one or more of the at least one requested mission ID does not overlap with any supported mission ID, the supported mission ID indicating at least one mission supported by at least one mission management function of the RAN; or
determining, by the RAN, one or more of the at least one requested mission ID is not supported by the RAN in a cell, a tracking area, or a network the terminal device requests to access;
sending, by the RAN, an initial terminal message to a core network (CN), the initial terminal message including the at least one overlapped mission ID and the one or more of the at least one requested mission ID; and
receiving, by the RAN, one or more allowed mission IDs of the at least one allowed mission from the CN.

9. The method according to claim 4, wherein the initial terminal message further includes one or more of: terminal device context or RAN capability.

10. The method according to claim 9, wherein the terminal device context includes one or more of: a cell ID identifying a cell that the terminal device is located in, a tracking area ID identifying a tracking area that the terminal device is located in, a public land mobile network (PLMN) ID identifying a public network that the terminal device is located in or requesting to access, a non-public network (NPN) ID identifying a non-public network that the terminal device is located in or requesting to access, or the terminal device's computing and communication ability on executing the mission.

11. The method according to claim 9, wherein the RAN capability includes one or more of: supported mission ID of the RAN, supported task ID of the RAN, or supported submission ID of the RAN.

12. The method according to claim 1, wherein receiving, by the RAN, the access request message from the terminal device comprises:
sending, by the RAN, at least one supported mission ID to the terminal device, before the RAN receiving the access request message.

13. The method according to claim 12, further comprising:
sending, by the RAN, the at least one supported mission ID together with one or more of: a cell ID, a network ID, or a tracking area ID.

14. The method according to claim 12, wherein sending, by the RAN, the at least one supported mission ID to the terminal device comprises:
sending, by the RAN to the terminal device, the at least one supported mission ID via one or more of: a broadcast message, a unicast message, system information, a radio resource control (RRC) message, a paging message, or a dedicated signaling message to the terminal device.

15. The method according to claim 1, further comprising:
receiving, by the RAN, an establishment request message from the terminal device, wherein the establishment request message is for requesting establishment of a mission data plane for a first requested mission, the first requested mission is one of missions indicated by the mission ID of the at least one allowed mission.

16. The method according to claim 15, further comprising:
determining, by the RAN, whether the RAN can execute the first requested mission by itself; and
sending, by the RAN, to the terminal device, a response message for successful establishment of the mission data plane.

17. The method according to claim 15, further comprising:
determining, by the RAN, the RAN is unable to execute the first requested mission by itself;
sending, by the RAN, the establishment request message to a core network (CN);
receiving, by the RAN, an establishment response message from the CN, wherein the establishment response message includes at least one of:
a mission ID of the first requested mission, a submission ID identifying a submission which is involved in the first requested mission and to be provided by the RAN, a task ID identifying a task which is involved in the first requested mission and to be provided by the RAN, a mission session ID identifying the mission data plane, or a mission context including an indication of whether the RAN should be involved in the mission data plane; and
sending, by the RAN, to the terminal device, a response message for successful establishment of the mission data plane.

18. The method according to claim 16, wherein sending, by the RAN, to the terminal device, the response message for the successful establishment of the mission data plane comprises:
sending, by the RAN to the terminal device, one or more of:
a mission ID of the first requested mission, a submission ID identifying a submission to be provided by the terminal device which is involved in the first requested mission, a task ID identifying a task which is involved in the first requested mission and to be provided by the terminal device, a mission session ID identifying the mission data plane, or a mission context including an indication on whether the terminal device should be involved in the mission data plane, a radio bearer ID, or a configuration parameter on a radio bearer identified by a radio bearer ID.

19. The method according to claim 18, wherein sending, by the RAN, to the terminal device, the response message comprises sending the response message via one or more of: a broadcast message, a unicast message, system information, a radio resource control (RRC) message, a paging message, or a dedicated signaling message to the terminal device.

20. An apparatus, comprising at least one processor and at least one memory coupled to the at least one processor, wherein the at least one memory stores instructions that, when executed by the at least one processor, cause the apparatus to:
receive an access request message from a terminal device, wherein the access request message includes at least one requested mission identifier (ID), the at least one requested mission ID indicating at least one requested mission;
determine at least one allowed mission from the at least one requested mission; and
send a mission ID of the at least one allowed mission to the terminal device.
